(19) United States
(12) Patent Application Publication
(10) Pub. No.: US 2018/0075404 A1
(43) Pub. Date: Mar. 15, 2018

(54) METHODS AND SYSTEMS TO OPTIMIZE TIMING OF CUSTOMER ARRIVAL AND ORDER PRODUCTION COMPLETION FOR REMOTE CUSTOMER ORDERS

(71) Applicant: KYLE JOHAN HENDRICKSON, WENATCHEE, WA (US)

(72) Inventor: KYLE JOHAN HENDRICKSON, WENATCHEE, WA (US)

(21) Appl. No.: 15/425,807

(22) Filed: Feb. 6, 2017

Related U.S. Application Data
(60) Provisional application No. 62/292,161, filed on Feb. 5, 2016.

(51) Int. Cl. G06Q 10/08; G06Q 50/30; G06Q 50/28; G06Q 10/06; G06Q 30/06; G06Q 50/04

(52) U.S. Cl. CPC G06Q 10/087; G06Q 50/30; G06Q 50/04; G06Q 10/063112; G06Q 30/0635; G06Q 50/28

(57) ABSTRACT

A method and system to timely execute the production or procurement of remotely ordered products while a consumer is in transit to the production and/or pickup site within a defined range of the consumer's estimated arrival time.

### PRIORITY CLAIM

This application claims the benefit of U.S. Provisional Patent Application Ser. No. 62/292,161 filed Feb. 5, 2016, which is incorporated by reference in its entirety as if fully set forth herein.

### COPYRIGHT NOTICE

This disclosure is protected under United States and/or International Copyright Laws. © 2017 Kyle Johan Hendrickson. All Rights Reserved. A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF THE INVENTION

The present invention relates generally to order processing of remotely placed orders by transiting customers and more specifically to the timing, estimation, and prioritized scheduling of order production and order production components to optimize the precision at which the order will be completed at about the same time as the customer arrives.

### BACKGROUND

Some vendors, e.g., Starbucks®, currently allow customers to place orders remotely, for example, via a phone, mobile application, or text message. These orders are entered into queues for pick up at the selected pickup site. Customers can even indicate expected pickup times which can then used as target completion times for vendors. By way of example, if a takeout pizza order is placed at 4:00 PM for a 5:00 PM pickup, the vendor receives the order information and may try to put the pizza in the oven at such time (e.g., 4:40 PM) such that it could be ready at 4:55 PM and be held warm until the customer arrives to pick it up.

For example, U.S. Pat. No. 8,732,028 entitled “Scheduling of Order Processing for Remotely Ordered Goods,” filed on Jan. 20, 2012 and issued on May 20, 2014, the contents of which is incorporated by reference in its entirety as if fully set forth herein, discloses an method of a computer-implemented method in which processing may be scheduled so that completion of order processing is expected to substantially coincide with arrival of the user at the provider location by obtaining and comparing the arrival estimate and the order completion estimate to schedule processing of the order. See id. at Abstract.

The ability to place remote orders and anticipate pickup times may offer a variety of benefits to the customer (e.g., less wait time) and the vendor (e.g., faster service, decreased staff, increased throughput). However, this very function of remote ordering/purchasing creates new problems such as mis-timed customer arrivals and/or order completions. For products that are able to be held for longer periods without meaningful degradation (e.g., certain food products like pizza or consumer goods like computer parts), mis-timing the completion of production closely to the customer pickup may be of less concern than for extremely perishable products whose perceived and/or actual value drops sharply with the passage of time (e.g., certain food products like a high-end espresso latte or life science type items like tissue or cell samples or organ transplants). For perishable products, the value of the vendor's offering can be easily destroyed by anything that hinders the precise coinciding of customer arrival and order production completion within a narrow window of time—regardless of whether it is the customer arriving later than expected or the vendor miscalculating the timing and completion of the order.

Accordingly, there is a need to better time the completion of remotely conveyed production orders within the expected arrival time of a transiting consumer.

### SUMMARY OF INVENTION

The present invention relies on novel methods and systems to optimize the timing of production of an order and/or consumable with its procurement at a particular destination (the “production site”) within a defined range of the consumer's expected arrival time to the production site. Hereinafter, the words “order,” “product,” “item,” and “consumable” shall be used interchangeably. The methods and systems allow for timely estimation and execution of the production or procurement of the remotely ordered products (and/or the components of a remotely ordered product) while the consumer is in transit to the production site within a defined range of the consumer's estimated arrival time.

Preferred and particular embodiments of the invention described herein allow for the generation of customer arrival predictions that are updatable depending on prior customer route patterns and changes in route transiting speeds by the customer and for order production estimates that are precisely and dynamically determined. For example, previous routes favored by the customer can be employed in particular embodiments described herein to dynamically optimize calculation of customer arrival times. Other alternate and particular embodiments of the present invention can optimize current methods and systems by overcoming the technical problems created by a remote ordering and processing system by employing a more detailed understanding and rendition of all the resources required for production and order completion, how much those resources can run in parallel depending upon staff levels, and even how different employees operate at different speeds and efficiencies.

Embodiments of the present invention generally use data gathering and processing systems that allow and facilitate the interaction and/or aggregation of data sources and types, including but not limited to data on customer proximity and estimated total production time for customer orders. In particular, the continual gathering of data on operations will further optimize and provide more precise estimated production times based on real-time constraints and resources as well as historical data, which can also give insight and recommendations for how to improve operations through training and investment in equipment capability/capacity. A preferred embodiment of the invention includes the enablement of the beneficial interaction between customer proximity data and a dynamic production queue. Other embodiments of the present invention also generally use a trigger that provides the logic for when a customer order should be entered into the production queue and process. The trigger logic can initiate different times in which the workers and/or tasks would be triggered into the production queue based on resource utilization levels and the different levels of perishability per item. For example, a drip coffee is extremely fast to make but less perishable. An employee can be directed to produce five drip coffees for the next five orders in the queue and have them ready by the window to be aggregated to other items comprising the order—this would increase efficiency by creating an inventory. The same employee can then be directed to make the more-perishable espresso drinks when the trigger logic initiates them/those tasks into the production queue. As such, embodiments of the present invention increase the precision and efficiency of production resource utilization and improve the quality of the trigger logic and outcomes.

One preferred method and system of the present invention employs qualifying laborer competence to prepare at least one menu item consumable based on the consumable complexity. “Consumable complexity” can be defined, for example, in terms of degree-of-production complexity in its preparation, manufacture, or procurement (e.g., complexity of the product and/or complexity of the process). The “consumable complexity” can also define the perishability of an item in more objective and/or quantifiable terms of edible and non-edible consumables. For instance, one consumable item among other consumable items can be provided in a listing or menu available for the consumer's selection (“plurality of consumables”), and some items on a menu are more complex or difficult to manufacture and requires different laborer skill levels to timely execute production no later than the calculated arrival time of the customer's pick-up. Other descriptors can also be defined to better delineate what complexity is, and subsequently, various mastery levels attained by different workers (“qualified laborers” or “qualifying laborer competence”) to qualify/quantify the skill level of workers for their subsequent production assignments (i.e., “assigning at least one qualified laborer”) as orders arrive and accumulate, thus triggering their placement in production queue schedules.

“Laborer” is used herein to mean at least one worker or at least one employee hired to perform production tasks at the production site, and “qualifying laborer competence” is used herein to mean using the available production resources (equipment and/or fellow laborers as needed) to ascertain and/or estimate the time to manufacture a given item or components making up the item. Hereinafter, the words “ascertain,” “estimate,” “calculate,” and “determine” shall be used interchangeably. At the production site, the systems and methods allow for remotely receiving an order at the production site for a consumable from a remotely located consumer whose proximity to the production site can be ascertained. Thereafter, an arrival time of the consumer to the production site is calculated from remotely conveyed proximity data from the consumer, either directly or indirectly, while the consumer is in transit to the production site. The systems and methods then employ assigning at least one qualified laborer to prepare the remotely ordered consumable within a defined range of the consumer arrival time's expiration. Preferred embodiments of the invention are sometimes conveniently referred to herein as the Trigger and/or the Proximity and Queuing Trigger (PQT) invention.

### BRIEF DESCRIPTION OF THE DRAWING FIGURES

Preferred and alternative embodiments of the present invention are described in detail below with reference to the following drawings:

FIG. 1 illustrates one embodiment of the present invention and describes a method to employ a Proximity Queuing Trigger (PQT) to effect the timely delivery of a remotely ordered consumable based on the proximity of a transiting consumer;

FIG. 2 illustrates another embodiment of the present invention and depicts a method for qualifying laborer competence;

FIG. 3 illustrates yet another embodiment of the present invention and depicts method to calculate an initial Estimated Arrival Time (EAT);

FIG. 4 illustrates still another embodiment of the present invention and depicts method to calculate a revised Estimated Arrival Time (EAT);

FIG. 5 depicts a map schematic of different routes taken from an ordering location to a single production site;

FIG. 6 depicts a map schematic of different routes taken from an ordering location to three distally located production sites;

FIG. 7 illustrates one embodiment of the present invention and depicts a schematic of a system employed to perform a method such as the one illustrated in FIG. 1;

FIG. 8 illustrates one embodiment of the present invention and depicts a method for estimating the total time required to complete a customer order;

FIGS. 9A and 9B illustrate the formulas and queuing model employed to perform the method illustrated in FIG. 8;

FIGS. 10A and 10B illustrate another embodiment of the present invention and depicts the production timing technology of the trigger;

FIGS. 11 through 16 illustrate different embodiments of the present invention and depict graphical representations of various Gannt-style estimations of production of item and item components to demonstrate with detail how the production of items and item components can be done increasingly in parallel when staffing is increased and increasingly in series when staffing is decreased;

FIG. 17 illustrates one embodiment of the present invention and depicts a dynamic staffing model dependent on a stipulated minimum service speed to efficiently allocate labor resources dependent upon meeting service level goals; and

FIGS. 18A and 18B illustrate one embodiment of the present invention and depict estimated order completion by regression.

### DETAILED DESCRIPTION OF THE PREFERRED EMBODIMENT

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that performs particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

One of the preferred uses of the present invention is in the high-end latte industry. As an example of the current state of the art, one way to order and pick up a latte is to place an order remotely through the Starbucks® mobile app and then go pick up the order at the specific Starbucks® location chosen by the customer. The order is input into that specific store's order/production system when ordered. Based at least in part on mapping software in the app, the customer may be shown her estimated travel time to the pickup location based on her current location. As other orders are completed, the customer's order moves up the queue and is completed in turn. The completion of the order may be before, at, or after the arrival of the customer. It is likely that the customer will either wait at the pickup site for the order to complete or the completed order will wait for the arrival of the customer. This is functionally similar to the usual way of calling in to a café and placing an order for a latte to go, checking travel time on the Internet, and then arriving to pick up the order. The customer may stipulate a time for the drink to be ready for pickup which may then be noted and an effort made to have the drink ready when the customer arrives.

The problem with this current state of the art is that the value of the vendor's offering can be easily destroyed by anything that hinders either the customer from arriving just after the completion of the order or the vendor properly timing the completion of the order. For a product as perishable as a high-end latte, there is a very narrow window of time after the product's preparation in which the product is at peak value to the customer. The product's appearance immediately begins to deteriorate and it begins to cool, which further devalues it, as it cannot be reheated or be kept hot and retain its value.

For instance, while the Starbucks® mobile app may allow for remote placement of orders and payment, which can eliminate two to three staff members per Starbucks® site, this very function of remote ordering/purchasing creates other problems such as mis-timed customer arrivals and/or order completions. The following table illustrates outcomes in a scenario where the customer places a take-out pre-order for a perishable good, like a latte, from a vendor:

| | Customer Early | Customer On-Time | Customer Late |
|---|---|---|---|
| Vendor | Customer pleased. | Latte cool. | Latte very cold. Remake |
| Early | Vendor Lucky. | Unhappy. | drink. Customer waits, |
| | | | vendor loses money. |
| | | | Unhappy. |
| Vendor | Customer waits, but | Everyone happy. | Customer's fault, but bad |
| On-Time | takes blame. Not good | Good outcome. | experience reflects poorly |
| | but OK. | | on vendor. |
| Vendor | Exacerbated customer | Unhappy customer. | Customer pleased. |
| Late | wait and bad | | Vendor Lucky. |
| | experience. Unhappy. | | |

Accordingly, while Starbucks® mobile app may decrease labor costs, the app may likewise decrease customer satisfaction. Product quality becomes very volatile due to mis-timings, which may lead to waste in re-making drinks, which may in turn further cause mis-timings of other orders because of the unexpected demand on production.

Embodiments of the present invention create value for vendors and customers by allowing the accurate timing of the entry of remotely placed customer orders into vendor production systems. This reduces potential mis-timings, whether the fault of the customer, the vendor or neither, and results in higher numbers of positive customer experiences of higher product value. Embodiments of the invention, which incorporate the Trigger element, create new and enhanced value to the remote ordering/purchasing because of their ability to generate and control a more sophisticated interaction with the customer.

Through the combination of the estimated arrival time of the customer and the intelligent, estimated timing of the queuing engine based on real-time and statistical data of production completion times of orders and order components, embodiments of the Trigger invention allows for a dynamic and more-accurate system for intelligently holding and placing remote customer orders into the production queues at vendors' pickup locations.

Embodiments of the Trigger invention put the customer order into production at a moment chosen by the vendor to maximize the value of the customer's experience in accordance with the vendor's understanding of his products' characteristics and his market's preferences. The risk of the customer mis-estimating their arrival time, for any reason under their control (or outside of it), is eliminated by the elimination of their estimation altogether. Therefore, “early” or “late” arrivals are constrained to the statistical probabilities of error in the proximity data or arrival time estimations provided by the method chosen to estimate the customer's arrival time through the chosen proximity data type. Moreover, the invention constrains the error in the vendor's order completion timing to the statistical variability in the Estimated Production Time for any orders in the vendor's local production queue. In one embodiment of the present invention, a software trigger comprised of the combination of proximity data with estimated local production queue and activity time can minimize customer wait time and maximize perceived value of perishable products.

The following revised table, when compared with the table of outcomes above, is a visualization of the significant improvement in outcomes the Proximity Triggers can provide to the vendor:

| | | Customer | | |
|---|---|---|---|---|
| | | Early | On-Time | Late |
| Vendor | Early | | | |
| | On- | | Everyone happy. Good outcome. | |
| | Time | | | |
| | Late | | | |

Furthermore, the accuracy of the software used by embodiments of the present invention can improve over time along an expected learning curve. Embodiments of the present invention can also afford the possibility of creating an evolved food service business model that requires no labor cost for taking orders or payments, that suffers no capacity constraints in order or payment taking, and that drastically cuts customer wait times without reducing product quality. Utilization of this invention's technology can open doors to sustainable competitive advantage and a higher profit per square foot.

Accordingly, one optionally advantageous feature of embodiments of the present invention is the data representing the proximity of the customer. Another optionally advantageous feature is the data representing the estimated time it would take a specific order to be completed if it were placed into the queue. It may be standard to place an order at the end of the queue, but an order's position in the queue can be expedited, if necessary and deemed beneficial by the logic of the system.

A preferred embodiment of the invention includes the enablement of the beneficial interaction between customer proximity data and a dynamic production queue. In this embodiment, for example, the logical flow of the order placement and Proximity Queuing Trigger (PQT) begins with the customer entering his or her order at a site from the pickup site. The mode of entry can be any method known now or in the future, including but not limited to the following options: website, mobile app, telephone voice call, text, instant message, and the like. The order then waits “on deck” in a database located on a server, e.g., a central server, a cloud-based server, or a server on-site at the pickup site. Each of the on-deck orders has an estimated production time (EPT) assigned to it by the production time database (PTD) based on the type and number of items in the order and the staffing level at the designated pickup site. Employee staffing levels are sent from the local staff scheduling system (a simple number on-staff in production roles) to the PTD. The PTD then uses the staffing level to understand the Gannt- and queuing-style EPT based on the makeup of each on-deck order. The total production time (TPT) is estimated for each order as the sum of all EPTs for all orders in the production queue at the pickup site plus the EPT for the subject order. The PQT monitors, collects and aggregates the EPT and customer location data, determines the optimal moment to enter each on-deck order into the production queue at each pickup site, and “triggers” each order into production. The customer then arrives at the pickup site and retrieves their order. The customer's account is charged for the order when they receive it and the order is cleared from the production system.

Other embodiments include system features, such as (i) an order timeout that asks the customer if they have changed their mind and/or if they do not wish to progress toward the pickup site within some reasonable amount of time and cancels the order if the customer does not show up; and/or (ii) a change of pickup site alert that is triggered by the customer moving in a significantly different direction than the site designated by the customer. In these embodiments, a mobile application, for example, can say something like, “Do you still want to pick up your drink at XYZ location? It may be more convenient for you to pick up your drink at Site1, Site2 or Site3.” The customer can, either directly or indirectly, move the on-deck order to another pickup location. In other embodiments, order placement and the pickup site can be split between two or more parties, such that, for example, a wife can order coffee and assign pickup to her husband, who would then accept the pickup invitation and pick up the coffee and the designated site on his way to see his wife.

A business model that utilizes the technology of directly combining the proximity data source and the estimated production time data source via the preferred embodiments of the present invention becomes capable of much higher throughput at much lower cost than a business not employing the present invention. In a preferred embodiment, utilizing both of the data sources is optionally advantageous. Any source of real-time proximity data can suffice on the proximity side. There are several possible solutions for constructing a dynamic production queuing system to provide an estimated wait time for production completion.

Proximity data can be provided by any type of system capable of delivering useful proximity data. The most obvious and potentially preferred types of proximity data may be GPS, WIFI, WIMAX, Bluetooth, and RFID, but any other source of customer proximity data can be useful to the system. GPS and WiFi location services from mobile phones may be the most ubiquitous and therefore the source of proximity data in a preferred embodiment. For example, the proximity data is currently an input for many mapping applications (e.g., WAZE, Google Maps, Bing Maps, et al). For instance, a mapping application like WAZE uses crowd-sourced traffic data and maps GIS data to dynamically estimate travel times from location to location. Other mapping applications, like Bing Maps, use GIS and public and private sources of data to supply estimated travel times. These mapping applications and/or other systems can be accessed for the estimated arrival time side of the Trigger. Embodiments of the present invention can beneficially combine current and future mapping applications (which can estimate arrival times based on GPS, traffic data, and geological map data) and/or other systems in a way that creates greater value to both the customer and the vendor.

In one embodiment of the invention, proximity data from mobile phone locations services is input into Google Maps or WAZE, which these applications use to estimate the travel time from a customer's location to the destination location, where the customer picks up their order. These travel time estimates can be repeatedly calculated such that the arrival time can be most accurately adjusted and calculated for each customer arrival.

The time till arrival from a GPS/Mapping application can be applied as the arrival estimate for the Trigger when using GPS/Mapping-type of proximity data. WiFi or Bluetooth networks can also give proximity data to the Trigger by, for example, triangulation data on a customer's proximity or simple notification that a customer's device has come within range of the network. While GPS location data may be more robust and preferable, any type of proximity data on the one side of the Trigger can be accommodated to allow the Trigger to profitably time the production of the customer's order.

Possible proximity trigger method options utilized in the present invention include, but are not limited to the following:

GPS Data Method.

In this embodiment, GPS data is sent periodically to the location system database. It does not matter what kind of device sends the GPS data as long as the data represents the location of the individual that will pick up the order (which can be the same person who placed the order or one to whom the pickup task has been delegated). The location system database logic runs estimated arrival times (EATs) based on traffic data similar to, for example, Google Maps or WAZE, and communicates those to the queuing system portion of the PQT. The location system database logic also handles and manages exceptions and user errors by (i) using “expected range” GPS data to ask whether the location chosen was the right one, (ii) using “expected range” GPS data to ask whether the customer changed their mind on the order, and (iii) otherwise verifying customer activities in attempt to improve order accuracy and timing and improve customer experience.

The production queue and/or on-deck database aspects of the PQT periodically receive the EATs for each on-deck order. The pre-arrival target (PT) is the target for how long before customer arrival each order should be completed (i.e. exit the production system). The PQT system decides when to place each on-deck order into the production queue by aiming for the PT time by dynamically balancing the customer EAT against the total of the estimated queuing wait time plus the estimated production time for the order (i.e., the customer's order's TPT). The PQT places the on-deck order into the production queue at the intended site at the optimal moment.

Short Range Radio Method (WIFI/Bluetooth®/and the Like).

In this embodiment, the pickup site can have an active short range radio, such as WIFI or Bluetooth®. The term WIFI is not limited to WIFI only, and can include WiMax technology and the like as well. The pickup site can identify customers by the unique identification of their mobile devices. The customer places an order remotely through their mobile app or online in a way that the order is connected to their customer account, which is associated with their mobile device ID. The remotely placed order is put the on-deck orders database. As the customer approaches the pickup location, the location short range radio system recognizes the presence of the customer device. Upon recognition of the customer device by the pickup site, the customer order is taken from on-deck orders and placed into the production queue.

RFID Method.

In this embodiment, this method works substantially the same as the short range radio method discussed above, except the event that triggers the entry of the on-deck order into the local production system is the detection of a unique RFID signal associated with the customer order. Depending on where the RFID signal can be detected, the timing of the order placement (the PT) into the production system can vary from site to site and situation to situation in order to optimize customer arrival with respect the completion of their order.

Other Satellite Method.

In this embodiment, other satellite methods or the like can provide customer location data, perhaps based on electronic signals sent from customer mobile devices or on visual tracking or some other means of tracking geographic data of the customers, and can work like the GPS Method described above.

Possible queuing estimation solutions for expected production wait times utilized in the present invention include, but are not limited to:

“High Level” Statistical Estimates.

In this embodiment, statistical estimates based on queuing theory models that receive high-level average/expected wait time and statistical distribution inputs based on production times based on estimated or actual data (e.g., time-study data) and their statistical distributions. These are called “high level” or gross variables because they are account for an “average order” level of detail. This is compared to a “low level” or “bottom-up” estimate (discussed below) which estimates the expected wait time by estimating the production time of all the components of all the orders in the queue ahead of the subject order plus the expected production time of the subject order. This “high level” method can operate upon mathematical/statistical “queuing theory” models, which responds to an input variable's average value and probability distribution. This method models the queue and estimates wait times by considering a “higher level” (or aggregate or gross variable), such as “average order production time.” With this method there may not be any consideration of the production times of individual items making up the order (i.e., a specific order may be comprised of a latte, a pound of whole bean coffee, a raspberry scone, and a 12 oz. drip coffee with cream). These kinds of variables can be an aspect of the input data in the queuing model along with its statistical distribution. A gross or average variable for expected production time can also be modified by other variables, such as staffing levels, specific employee factors, equipment factors, process factors, etc. These factors can drive the accuracy of the average production time. This average or gross treatment of estimating production time is one embodiment of the invention that provides optional advantages over the current state of the art of order and payment taking and order production timing.

“Low Level” Statistical Estimates.

In this embodiment, the summing of “low level” expected production time estimates based on detailed, by-item, aggregated production time averages and their statistical distributions. For each order, the expected production time can be estimated based on parameters such as: the consideration of the items composing each order, each item's expected demand on production resources (staff, equipment, and the like), the levels of available production resources, the variability observed in the production process of each item, and the nature of the production of each item's relationship to the other items being simultaneously demanded or produced (e.g., capable of parallel or only serial production). Whether an item can be produced in parallel or in series can be optionally advantageous to the expected production time of each order.

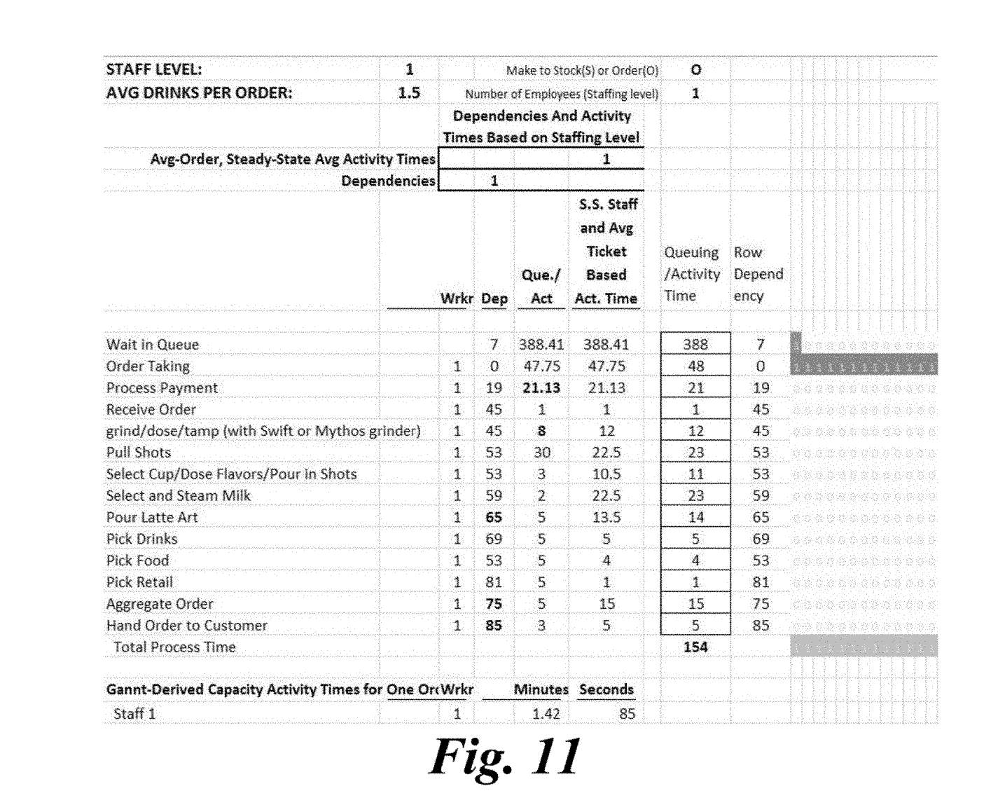

In embodiments of the present invention, the logic used to understand whether the production of items, which preferably comprise an order, can be done in parallel or in series. One example of such logic and method is critical path scheduling. One embodiment of the present invention, for instance, utilizes Gannt charting. As such, in this and alternate embodiments of the present invention, for each item, the required equipment type and time, the labor type and time, or any possible dependencies between items or production resources or any other pertinent data can be mapped out. Once these demanded resource variables are understood per item, it is possible to understand the degree to which an order's items can be produced in parallel or in series. A low “level order” production time estimate can apply a Gannt format to estimate the total order production time of any given order by mapping all dependencies between items, making all items parallel which can be, given the parameters, and setting all items as serial which must be, and finally reporting the expected total time for the order, based on the specific interaction of all these factors, and any other demands put on production resources outside of the subject order. FIGS. 11-16 demonstrate one embodiment of Gannt-like logic used for a bottom-up estimate of order production time.

Using a bottom-up or “low level” estimation for expected production times may be a preferred embodiment for the estimated production time side of the present invention. Bottom-up estimation may provide better accuracy in estimating the total wait time, due to a more detailed estimation of production times per item and based on, for example, the Gannt-type logic accounting for parallel versus serial production of inter-order items and intra-order items.

GPS data-based proximity trigger in conjunction with detailed queuing/production time estimates detailed by item may be a preferred embodiment. GPS data can come from, for example, a mobile phone app, from an app built into an automobile, from a GPS watch, tablet, laptop, or any other GPS enabled equipment. This solution can work well for both drive-thru, walk-up, and/or walk-in applications for food service and other perishable products or products that follow any “remote-order→production→customer pickup” process that would benefit from timing customer arrival with completion of production.

In one embodiment of the present invention, one may utilize: (1) a means of taking orders remotely (e.g. a mobile phone app or website, etc.); (2) a means of receiving timely information on the customers proximity or location (e.g. GPS data from a mobile phone or automobile); (3) a point of sale system that logs customer orders into a queue with the detail of their makeup by item; (4) a database that can be referenced to supply an estimated production time for each order in the queue conditional upon the production capacities of staffing and equipment at the specific pickup site; and (5) a software Trigger program that would provide the logic for how to match up the estimated arrival time of the customer to the estimated wait and production time of the customer's order (e.g., the Trigger can be set to place the order into the production queue when it is estimated that the customer's order would be completed 20 seconds before the customer's estimated arrival).

Alternative embodiments of the invention include, but are not limited to: different proximity data sources to use for the proximity trigger and different methods of estimating the total wait time until an order put immediately in the queue would be completed.

Different statistical methods, like the use of gross or high-level data input into a queuing model, for determining average order wait and production times may be advantageously used in conjunction with some embodiments. The use of a preferred logical Trigger for timing production of remote orders through the combination of any source of proximity data with any kind of estimated total order flow time through a production queue and production process can yield significant improvements in customer satisfaction and production quality and value. Regardless of whether a top-down method of understanding the average order flow time or a detailed, bottom-up method compiling many smaller averages is used, there are many different choices for how to design the calculations or interpret the variables or set the variables' values. While use of a statistical queuing theory model can improve the accuracy of expected wait times, it is also possible to use simple estimates to establish the expected flow times. In accord with the disclosures in this application, an embodiment using a simple estimate for average order flow time, when combined with a proximity trigger, can yield optionally advantageous features upon the conventional order/production process. There can be much learning that can improve the accuracy of the chosen embodiment over time. These learnings can deal with all aspects of the invention: proximity data communication, how to tune the trigger timing to various proximity data sources and/or customer or vendor needs, and improvements to the order flow time estimation and statistical dependability. Embodiments of the present invention can incorporate machine learning, human learning, or combinations thereof.

There can be many small or large adjustments or refinements in the models used or the type of model used. It can be sophisticated or basic, but the presence of a preferred trigger as described herein that uses customer proximity data and the expected order flow time (wait time plus production time) in order to place the customer order at an optimized time for product quality and customer satisfaction can provide immediate and/or continuous optionally advantageous improvements over the prior art.

Yet another embodiment of the present invention can be utilized behind the scenes with only tangential offers made to customers of “improved order timing” or with new no-wait/no-pay drive-thru or walk-up lines at quick serve restaurants, food trucks, food kiosks, and the like.

Still another embodiment of the present invention includes optionally advantageous improvements to the production estimation in addition to improvements to the trigger logic (such as the previously discussed improvements that result from a detailed understanding of all the resources required for production and order completion, how much those resources can run in parallel depending upon staff levels, and even how different employees operate at different speeds and efficiencies). These insights about employees can help with hiring and firing and training and gaining efficiency in the human resources department/management of the business. Large amounts of data can be gathered on business operations in order to learn how to better both the estimate production times based on real-time constraints and resources in order to give insight and recommendations for how to improve operations through training and investment in equipment capability/capacity.

One embodiment of the present invention is a tool that can enables the profitable use of two sets of data. This and alternate embodiments of the present invention can seek to time the production of a product or service to the arrival of a customer. The timing can be fine-tuned by the business, in such a way that appears to be most profitable to the business, according to the goals and needs of the business in serving their customer. Further development of the wait time estimation side of the PQT can include the development of a proprietary software solution that estimates the wait time of any given order depending on the production flow time for each component of an order, the staffing level at the pickup site, the resources demanded by each part of an order, the number and composition of all orders already in the queue, and the production time of the subject order. Learning can further improve the design of this estimation system, and therefore other variables can be introduced and utilized to, for example, more accurately and dynamically estimate the total wait and production time of any given order at any given pickup site.

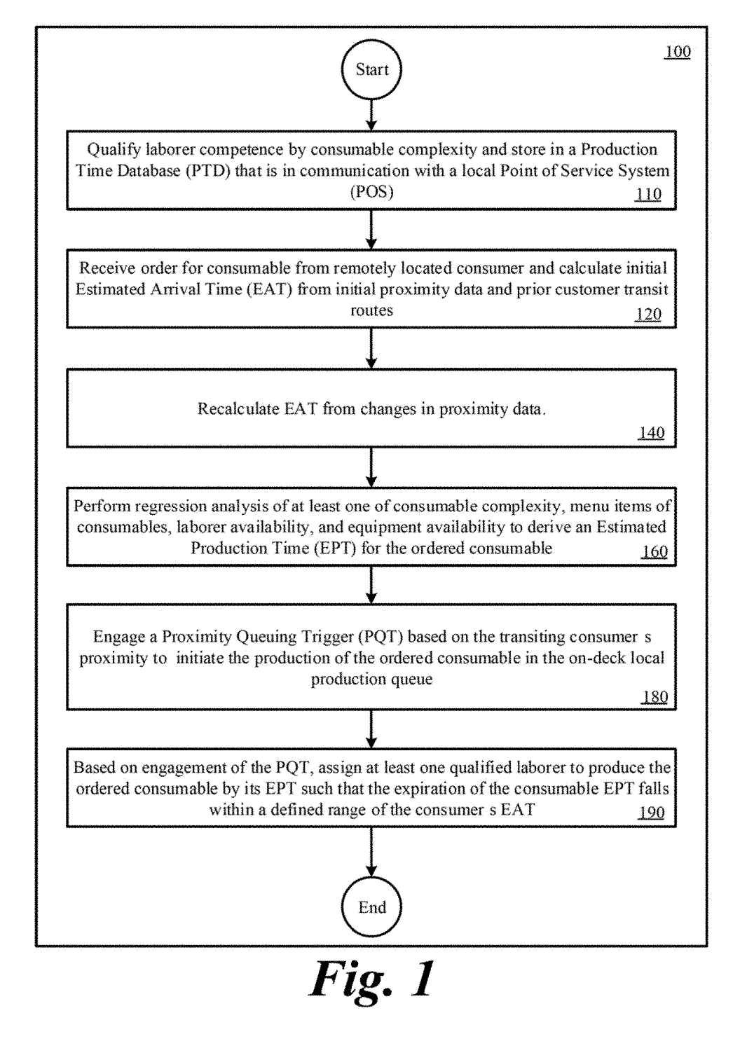

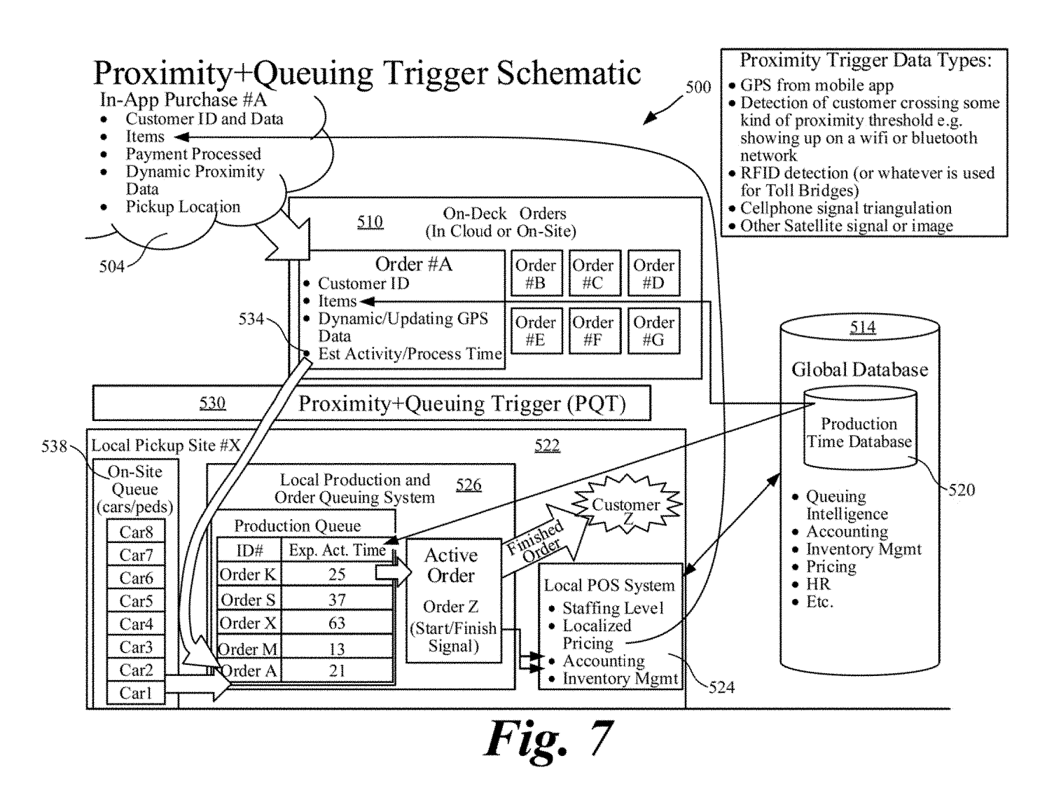

FIG. 1 describes a method 100 to employ a Proximity Queuing Trigger (PQT) to cause the timely delivery of a remotely ordered consumable based on the proximity of a transiting consumer. Method 100 includes process block or sub-algorithm 110 that qualifies laborer or worker/employee competence by consumable complexity and stores the qualifications within a Production Time Database (PTD) 520 that is in communication with a local Point of Service System (POS) discussed more fully in FIG. 7 below. Thereafter, method 100 continues to sub-algorithm 120 that provides microprocessor executable instructions to receive orders from remotely located consumers and to calculate an initial Estimated Arrival Time (EAT) from initial proximity data and any historical customer transit route information from PTD 520. Thereafter, at process block 140, should there be changes detected in the proximity data of a transiting consumer, microprocessor executable instructions provide for the reception of transmitted proximity data from the consumer to calculate at least one of change in route direction and/or changes in consumer velocity or speeds that can occur should the transiting consumer start riding a bicycle or catch a ride in an automobile. Thereafter, method 100 continues with process block 160 wherein regression analysis is undertaken to ascertain the expected effect of individual production factors (e.g., menu items, menu item modifiers, number of production staff present, identity of employees, equipment being utilized, etc.) on order production times. The analysis can also reveal variances detrimental to operational efficiency or variances enhancing operational efficiency to timely manufacture remotely ordered consumables. The timely manufacturing aspect is derived as an Estimated Production Time (EPT) 534 discussed in FIG. 7 below. Method 100 then continues with block 180 where engagement of a Proximity Queuing Trigger (PQT) 530, described in FIG. 7 below, is activated. The activation of PQT 530 is based on proximity data received that indicates when to initiate production of the transiting consumer's order by placing that order in a local, on-deck production queue at the production facility. Method 100 concludes at process block 190 wherein, based on the engagement of the PQT 530, at least one qualified laborers is assigned to produce the placed-in-queue ordered consumable. The at least one qualified laborer then executes the timely manufacture of the ordered consumable within its EPT 534 such that the EPT 534 falls within a defined range of the consumer's EAT.

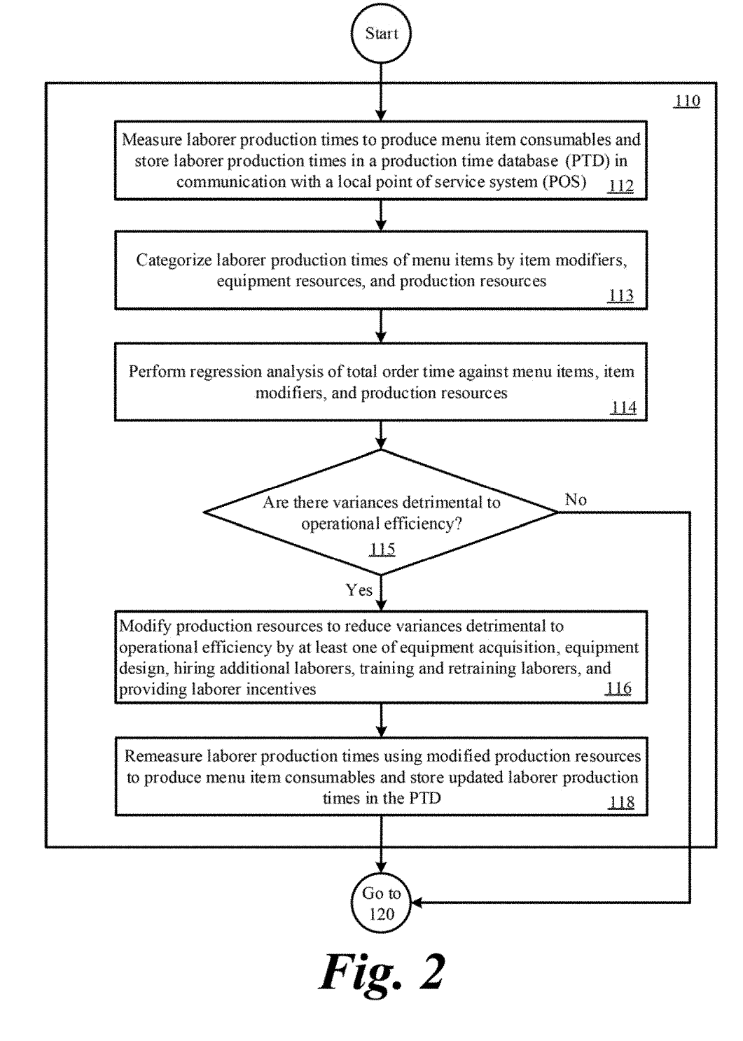

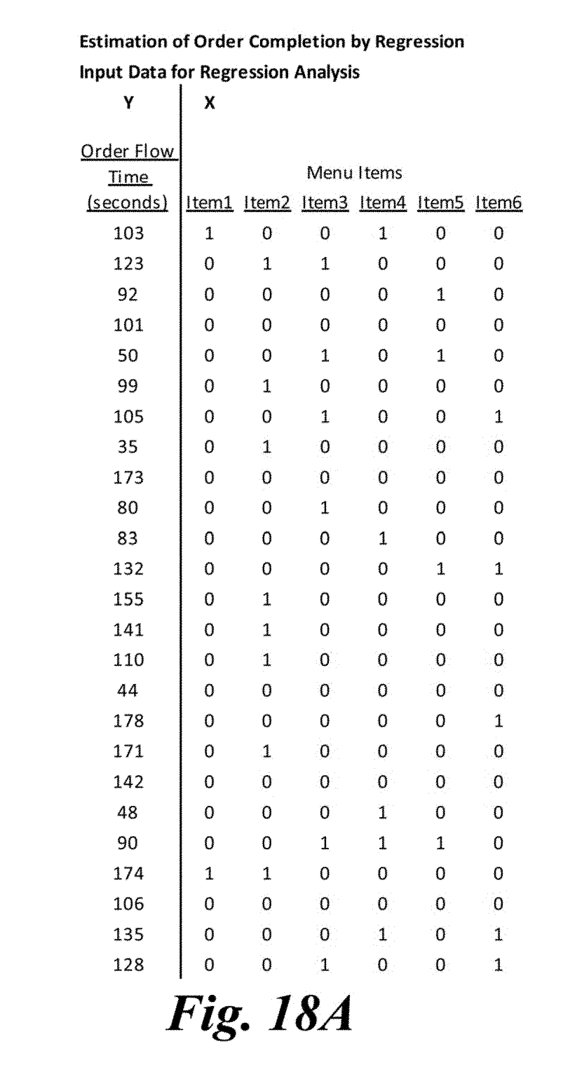

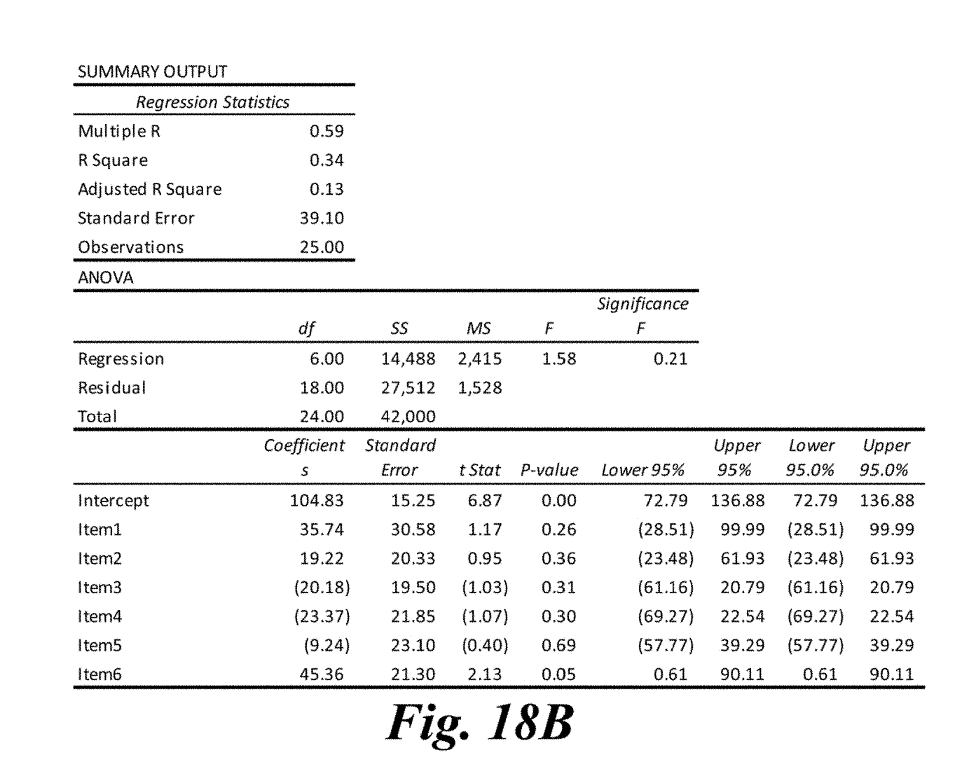

FIG. 2 describes sub-algorithm 110 for qualifying laborer competence of the method 100. At process block 112, the laborer production times are measured for menu item consumables and these production times are stored in the PTD 520. The stored production times are retrievable from the PTD 520 via the POS 524. At block 113, laborer production times of menu items are categorized against item modifiers, equipment resources, and production resources. FIG. 18A presents a simplified visual representation of how total order production time per order can be arranged for regression analysis against each order's composition of individual menu items and other resources (latter part not depicted on FIG. 18A). These categorized production times are stored in the PTD 520. Then, at block 114, regression analysis is performed to determine positive and negative variances, that is, production time variances positive for enhancing operational efficiency, or production time variances detrimental to operational efficiency, for the range of classifiers of total order time against menu items, item modifiers, and production resources. Next, at decision diamond 115, should the answer to the query “Are there variances detrimental to operational efficiency?” be affirmative, then sub-algorithm 110 proceeds to block 116. If the answer is negative, then sub-algorithm 110 proceeds to sub-algorithm 120. For the affirmative pathway, at block 116, those production resources presenting negative variances and thus detrimental to operational efficiency are modified by at least one of equipment acquisition, equipment design, hiring additional laborers, training and retraining laborers, and providing laborer incentives. Thereafter, sub-algorithm 110 is concluded at block 118 whereby laborer production times using the modified production resources are re-measured in regards to the ability to timely produce menu item consumables. The new total production times for each menu items by laborer is updated in the PTD 520.

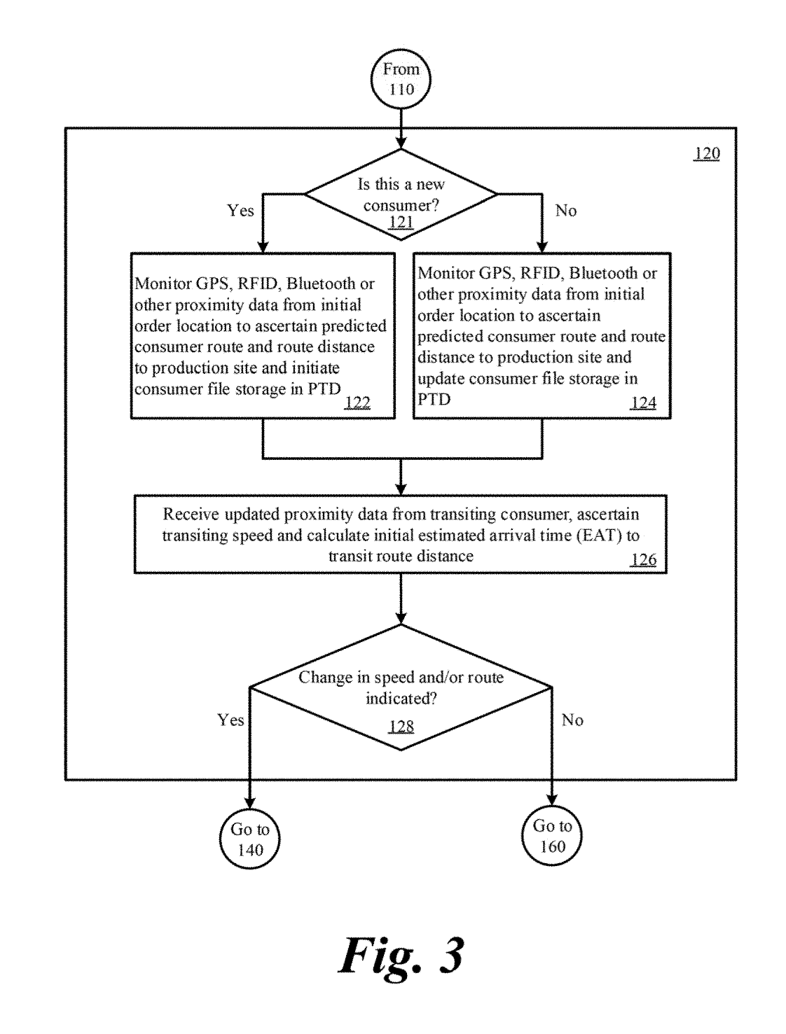

FIG. 3 describes sub-algorithm 120 to calculate an initial Estimated Arrival Time (EAT) of the method 100. After process sub-algorithm 110 is completed, sub-algorithm 120 provides for the calculations of initial and any revised Estimated Arrival Times (EAT) of a transiting consumer to the production site of the ordered consumable. Sub-algorithm 110 begins with decision diamond 121 with the query “Is this a new consumer?” If the answer is affirmative, then the next step is process block 122 where available proximity data (GPS, RFID, Bluetooth or other proximity derivable data) is monitored, measured, and a data file for the new consumer is created for storage in the PTD 520 that is then retrievable by the POS 524 for predicted routes, and route distances. If the answer is negative, then proximity related data is collected to determine routes previously taken or new routes that might be taken based upon historical data retrievable from the PTD 520 by the POS 524. The existing consumer's file is then updated at the PTD 520. New and existing consumers then converge at block 126 where updated proximity data from the transiting consumer is used to ascertain transiting speeds and to calculate initial estimated arrival times of the transit route distance to the production site. Thereafter, sub-algorithm 120 is concluded at decision diamond 128 having the query “Change in speed and/or route indicated?” If affirmative, the next sub-algorithm is 140, and if negative, the next sub-algorithm is 160.

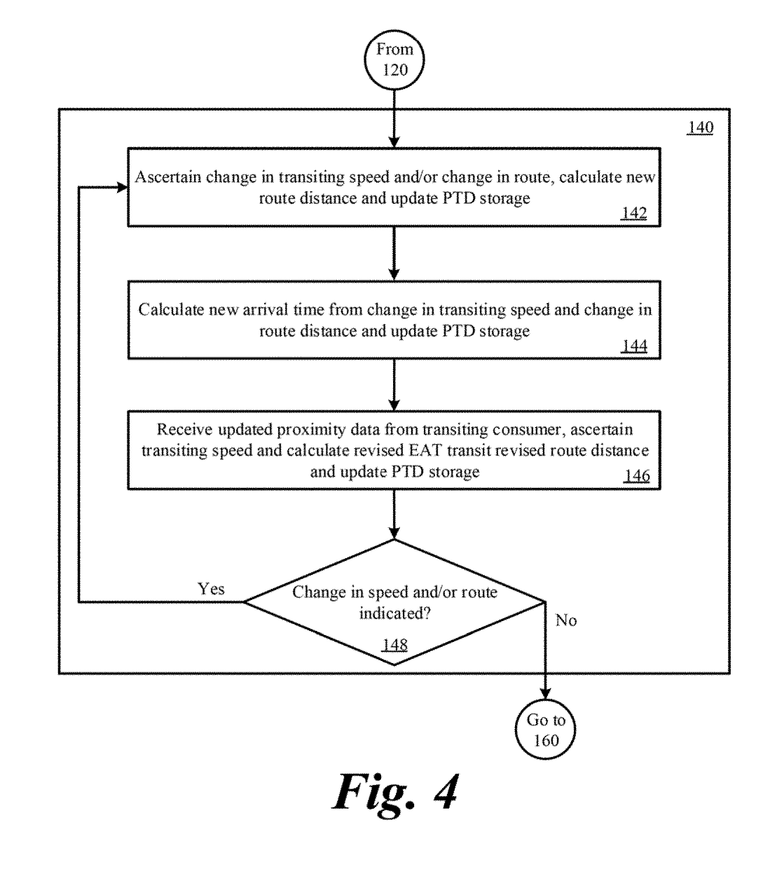

FIG. 4 describes sub-algorithm 140 to calculate a revised Estimated Arrival Time (EAT) of the method 100. Should there indications for a change in speed, velocity, or route direction, sub-algorithm 140 begins with block 142 in which changes in proximity data that indicate directional change and/or velocity changes are ascertained. Then, at process block 144, calculations of new arrival times from any changes in transiting speed or route distances. Then, at process block 146, revised EAT are determined from the updated proximity data received from the transiting consumers, and the revised EAT, routes, and route distances are updated in the PTD storage 520. Thereafter, sub-algorithm 140 is concluded at decision diamond 148 having the query “Change in speed and/or route indicated?” If affirmative, then algorithm 140 recycles to sub-algorithm 142. If negative, then process continues to block 160.

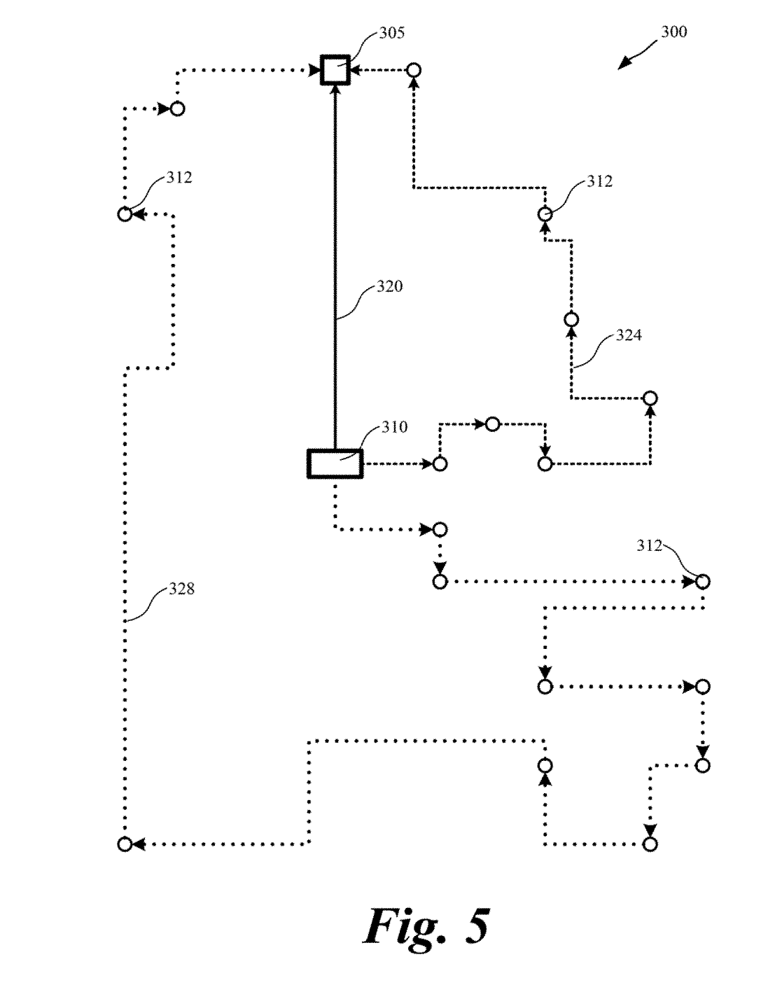

FIG. 5 depicts a map schematic 300 of different routes taken from an ordering location to a single coffee shop. A production site represented as a solitary coffee shop 305 is located at a linear distance from ordering locale 310 as indicated by the straight route 320. Other routes are shown that are circuitous with various layover sites 312. For example, should a consumer not undertake the straight route 320 directly to the coffee shop 305, say route 324 having seven layover sites 312 having 8 sub-sections, then many revisions of EATs would be expected since there is many changes in route directions and different route distances as compared with linear line-of-sight route 320. Alternatively, another consumer may take even a longer circuitous route to coffee shop 305 via route 328 that includes eleven layover sites 312 and twelve route segments. Thus if transiting along route 328 via on-foot, then bicycle, then car, similarly would require the method 100 to provide a series of revised EATs.

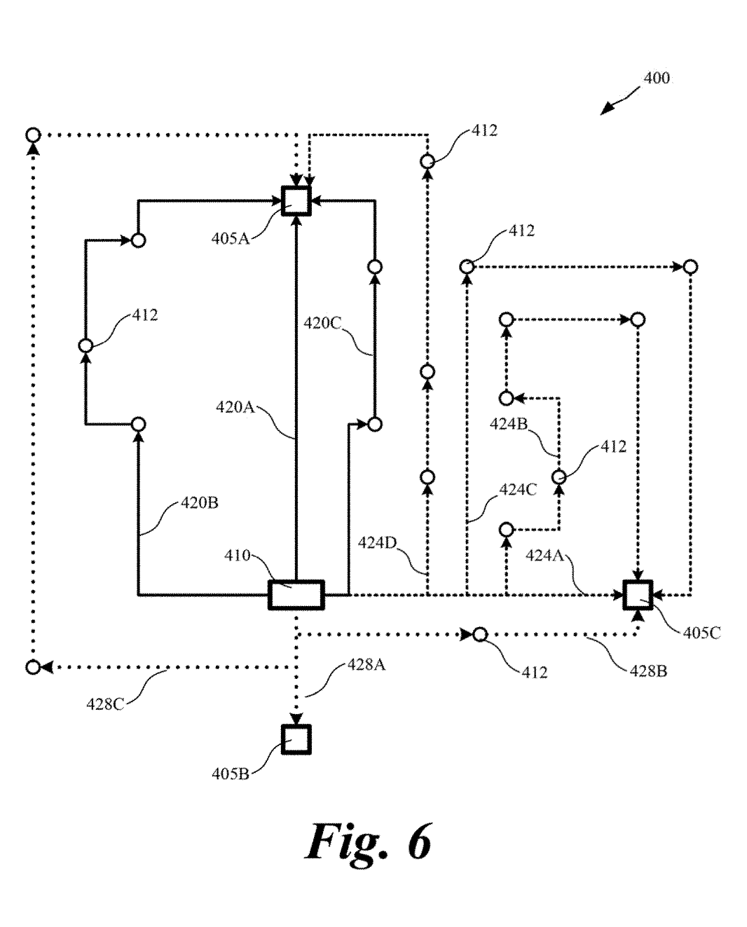

FIG. 6 depicts a map schematic 400 of different routes taken from an ordering location to three distally located coffee shops 405A, 405B, 405C from ordering location 410. In this schematic are depicted multiple routes associated with one consumer who habituates coffee shop 405 A via routes depicted in solid lines route 420A (straight, no layover site 412), route 420B (circuitous, having three layover sites 412 and four route segments), and route 420C (circuitous, shorter than 420B, with two layover sights 412 and three route segments. A second consumer habituates more both coffee shop 405C and 405A, with one linear route, dashed line 424A, circuitous routes 424B and 424C, and then a circuitous route 424D to coffee shop 405A. Then, a third consumer, via dotted routes 428A, 428B, and 428C equally habituates coffee shops 405A via circuitous route 428C, coffee shop 405B by straight route 428A, and coffee shop 405C via slightly circuitous route 428B. All these routes will present different needs by the algorithm 100 to calculate multiple EATs and the behavior patterns of the first, second, and third consumers is stored in the PTD 520 and retrievable by the coffee shops 405A/B/C via the POS 524 described in FIG. 7 below.

FIG. 7 depicts a schematic of a Proximity Queuing Trigger system 500 employed to perform the method 100 via interacting components. System 500 includes an In-Application Purchase or In-App 504 component that enables customer-related storage on-site at the production facilities' POS 524 or on a remote server (cloud) entity, the In-App 504 section having customer identification and data associated with prior ordered items, payment arrangements, dynamic proximity data, and preferred pickup locations or consumable production sites. Other components of the system 500 includes an on-deck order queue page display 510 in communication with the In-App 504 component, a global database 514 having a production Time Database 520. The global database 514 includes software programs having microprocessor executable instructions to ascertain queuing intelligence, accounting processes, inventor management, menu item pricing, human resources (HR) and other data subsets. The global database 514 is in communication with a production entity's local Point-Of-Service system (POS) 524. From the POS 524 are software programs having microprocessor executable instructions to estimate activity and Process times 534 and to engage a Proximity queuing Trigger 530 or PQT 530. The local POS 524 also in conjunction with the global database 514 and its Production Time Database includes those microprocessor executable instructions to execute the PQT 100 algorithm and sub-algorithms described in FIGS. 1-4 above.

The system 500 further includes a local pickup entity 522 or pickup site “X” that is represented by the coffee shops 305 and 405A/B/C exemplary described in FIGS. 5 and 6 above. Presentable on local monitors have access to the POS 524 or off-site server storage facilities is the On-Deck Order Queue page display 510. The page display 510 presents a series or orders from consumers A-G, each consumer order associated with customer ID#, items in a given customers order, dynamic updating of changes in proximity data of the transiting customers A-G, and process times and estimated process times or EPT 534 and estimated arrival times (EAT) of the orders A-G. By engagement of the PQT 530 via method 100, the On-Deck orders A-G are prioritized for placement within production queue by a local production order queuing system 526 viewable on monitors by personnel employed at the local pickup entity 522. As shown in this example a series of orders K, S, X, M and A have respective estimated activity times of 25, 37, 63, 13, and 21 seconds. As shown Order #A on on-deck page 510, based on order A's proximity data and EPT 534, it is given priority over orders B-G and placed by the PQT 530 into the local production site 522 local production queue by order queuing system 526. Order A of customer A who will arrive by automobile in placed within Car 1 slot as shown in the On-Site Queue 538 for Cars and pedestrians, Order A, now in queue sequence, will bump up once Active Order Z is categorized as a finished or fulfilled order to Customer Z arriving at local pickup site 522 or production site 522.

A system as illustrated in FIG. 7, which provides means for aggregating multiple data sources, including but not limited to customer proximity data combined with estimated wait and production times and also preferably based on queuing theory calculations and real-time data at the point of sale/production, can enable dramatic reduction of customer queuing/wait time at the point of purchase, elimination of employee staffing cost required for taking customer orders and/or payments, and/or potential process bottlenecks at the order-taking and/or payment process step, which combined can result in much higher revenue through higher throughput. Especially with respect to the production estimates and staffing allocations. Exemplary embodiments described for the system described in FIG. 7 provides for a system to optimize the timing of production of a consumable for pickup by the customer at the production site can occur with a defined period of the customer's arrival at the production site. The system 500 includes the global database 514 with its Production Time Database 520. The system 500 utilizes a plurality of microprocessor-executable programs. One program is designed to execute instructions for the acquisition of queuing intelligence, accounting data, inventor data related to the consumable, personnel competence data to produce the consumable, equipment to utilize to produce the consumable, and to utilize data stored in the Production Time Database 520. Another or second microprocessor-executable program includes instructions to detect consumer locations or changes in consumer location relative to the production site, storage of consumer location within the Production Time Database 520 so that the placement of the consumable within a production queue at the production facility can be initiated. This placement of the consumable in the production queue, along with assignment of the needed qualified production staff or personnel, allows for the optimized completion or finishing of manufacture of the consumable within the defined period of the customer's arrival time at the production site.

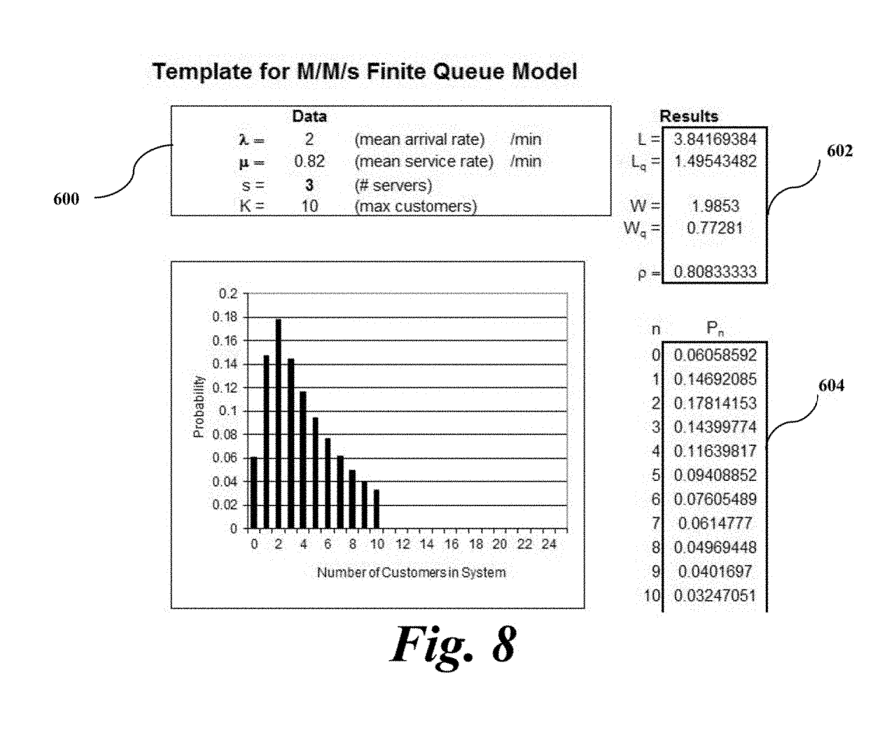

The production timing side of the Trigger can be supplied by any number of estimation methods. For example, production data can be obtained through the use of Microsoft Excel to model the production time of an average customer order. In one embodiment of the invention, queuing models in Excel can be used for figuring throughput on the order taking and payment processing steps of a traditional drive-thru. FIG. 8 illustrates one type of model that can be used to estimate waiting time in a production queue: a finite queue model, in which only a certain number of units can fit in the queue. Data 600 is used to generate results 602 and probabilities 604. Data 600 is comprised of variables such as λ (mean arrival rate), μ (mean service rate), s (# servers), and κ (maximum customers).

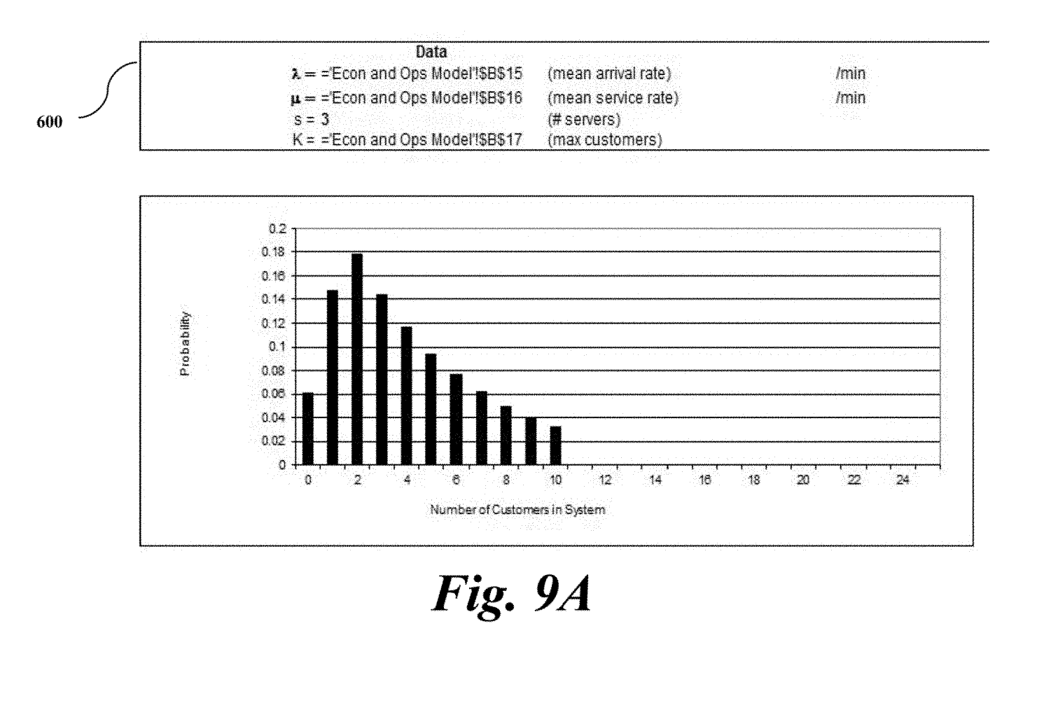

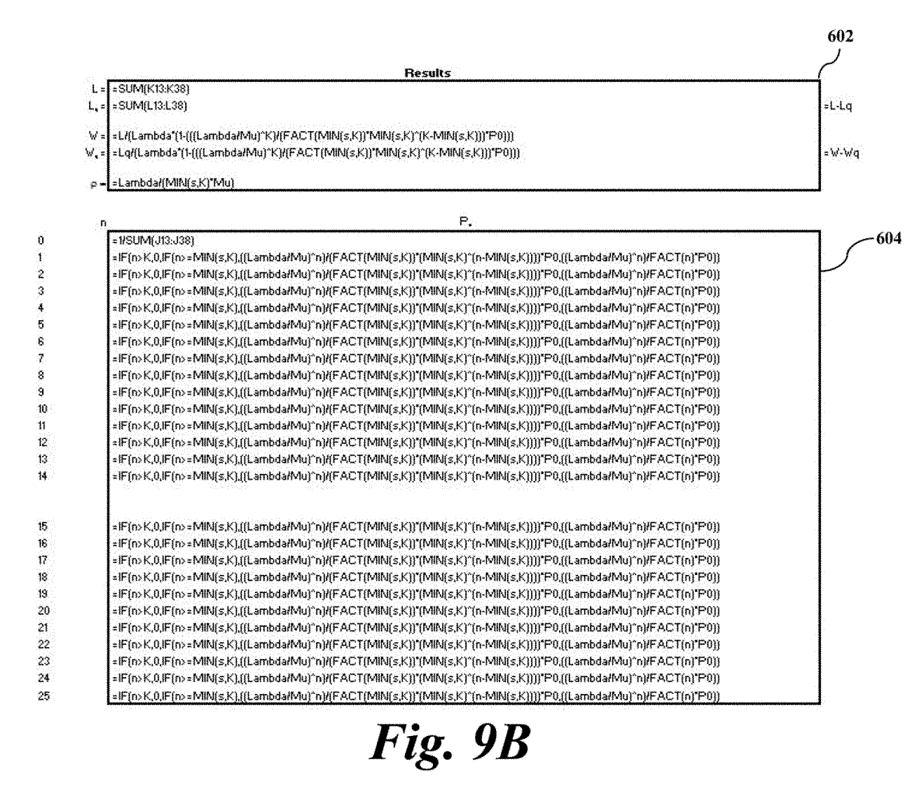

FIGS. 9A and 9B depict the formulas used in the queuing spreadsheet as illustrated in FIG. 8. In FIG. 9A, the formulas depicted in data 600 correspond to the data 600 as illustrated in FIG. 8. Similarly, in FIG. 9B, the formulas depicted in results 602 and probabilities 604, respectively, correspond to the results 602 and probabilities 604 as illustrated in FIG. 8.

An Infinite Queue model (not depicted here) is another one of many other statistical models that can be used profitably to dynamically estimate the total wait times for customer orders. These methods coincide with the top-down type of modeling with respect to the queuing side technology.

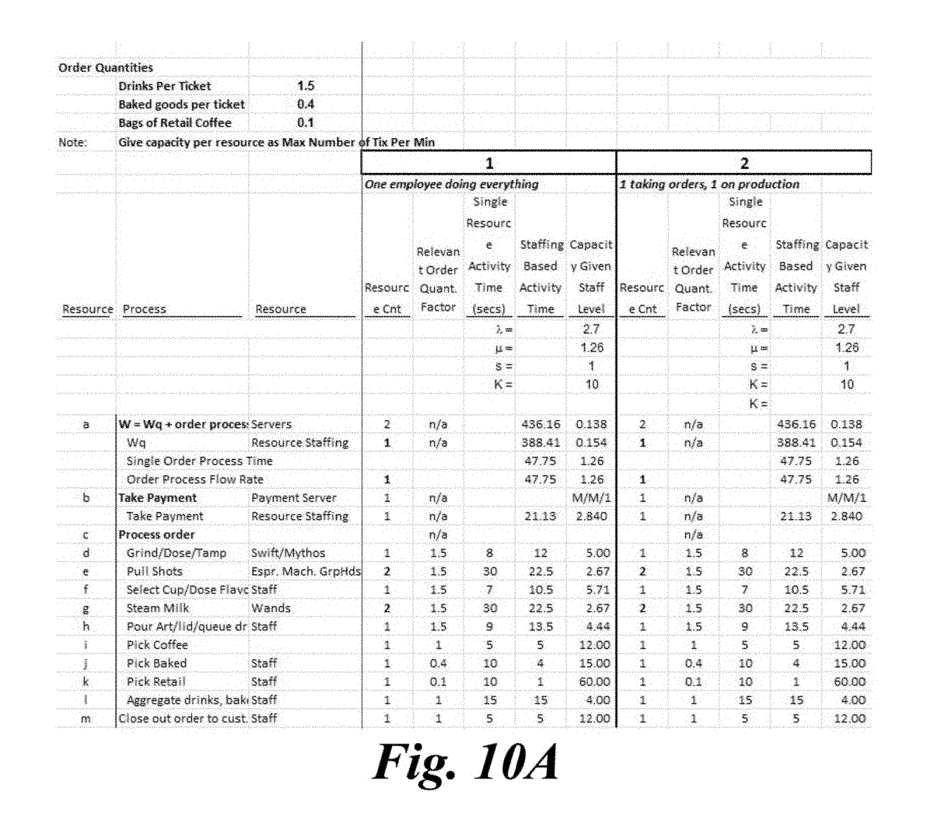

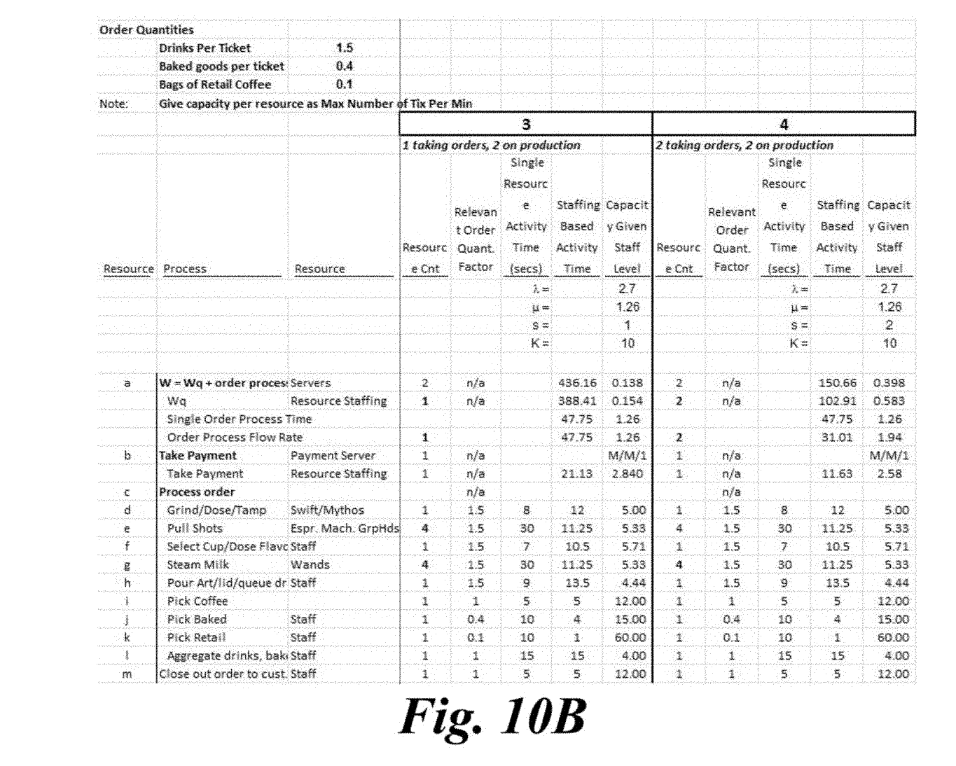

In another embodiment of the present invention, the “bottom-up” estimation of item production times is used in conjunction with Gannt-type logic to estimate the total wait time of an order based on all items and orders in the queue. FIGS. 10A and 10B illustrate how detailed production variables can be defined and conditioned on resource availability (e.g., staffing level, machine capacities, etc.). Logic is applied to determine what production processes per item and across items can be completed in parallel versus which can be done in series.

Together, FIGS. 11-16 each show graphical representations estimating order production/flow times at a level of estimation granularity. Gannt resources are tasked with producing items coincident with an average/expected order. In some embodiments, the estimation assumes that all resources are engaged in parallel production as much as possible, given the model assumptions.

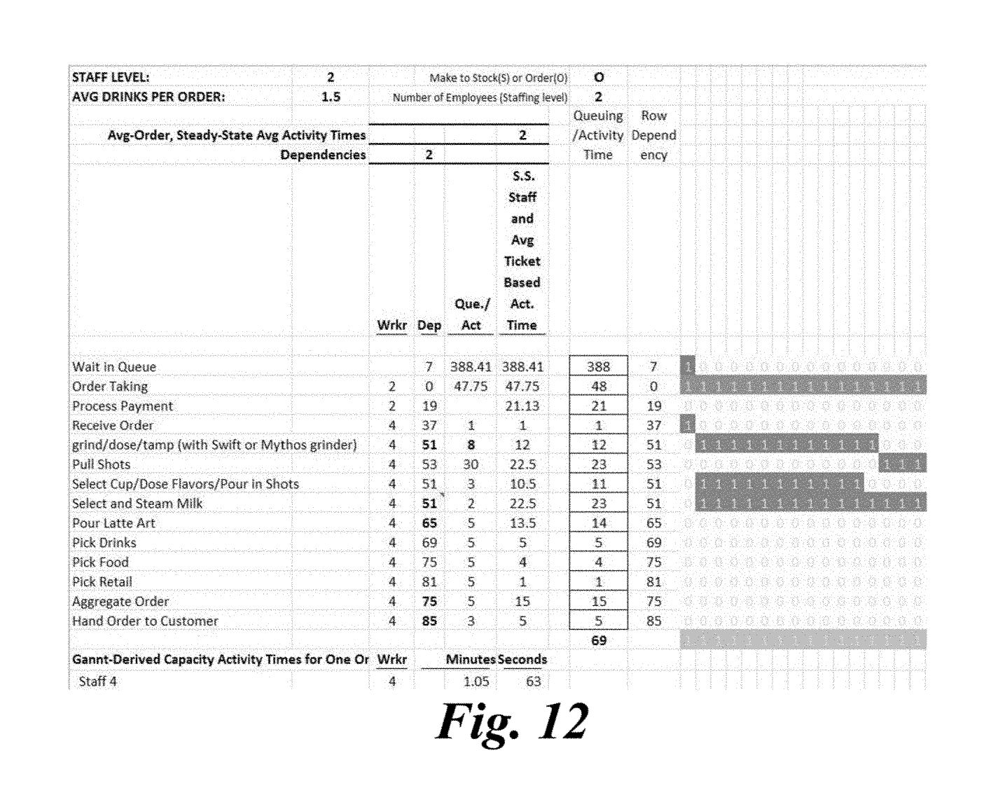

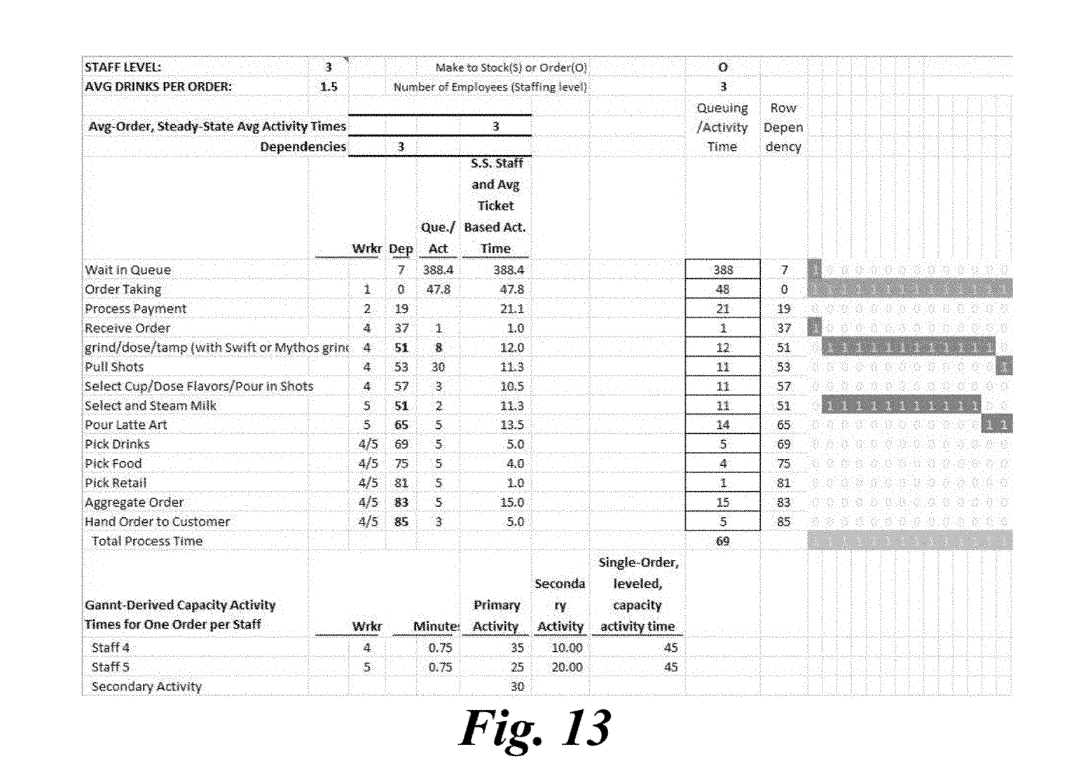

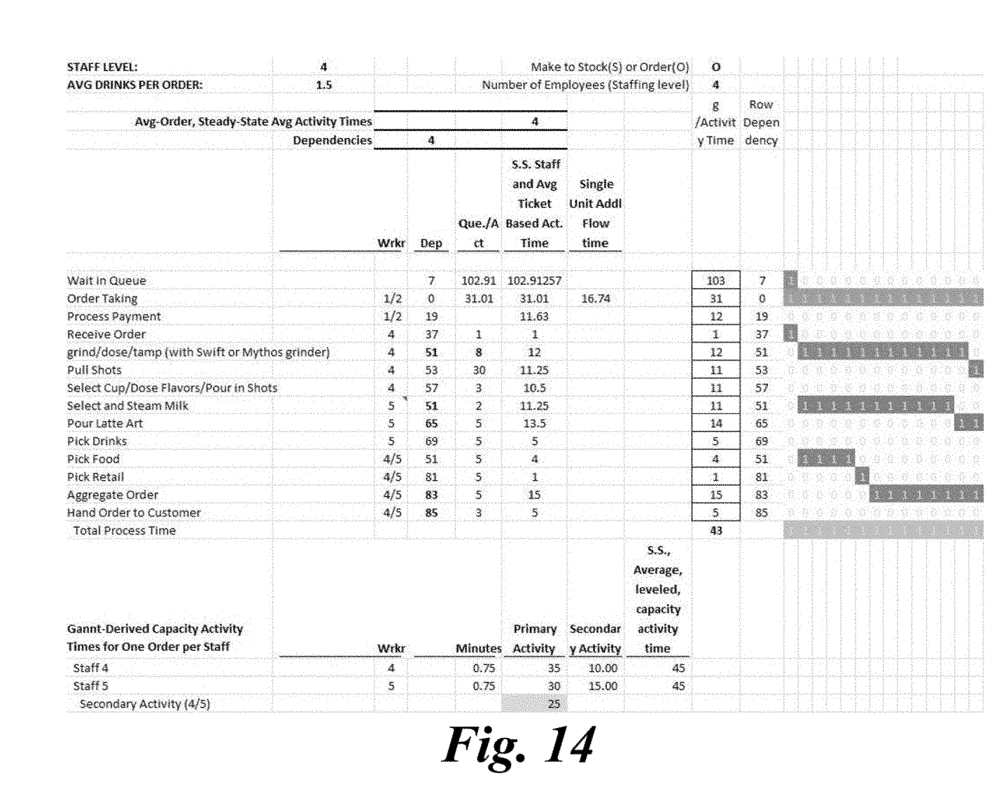

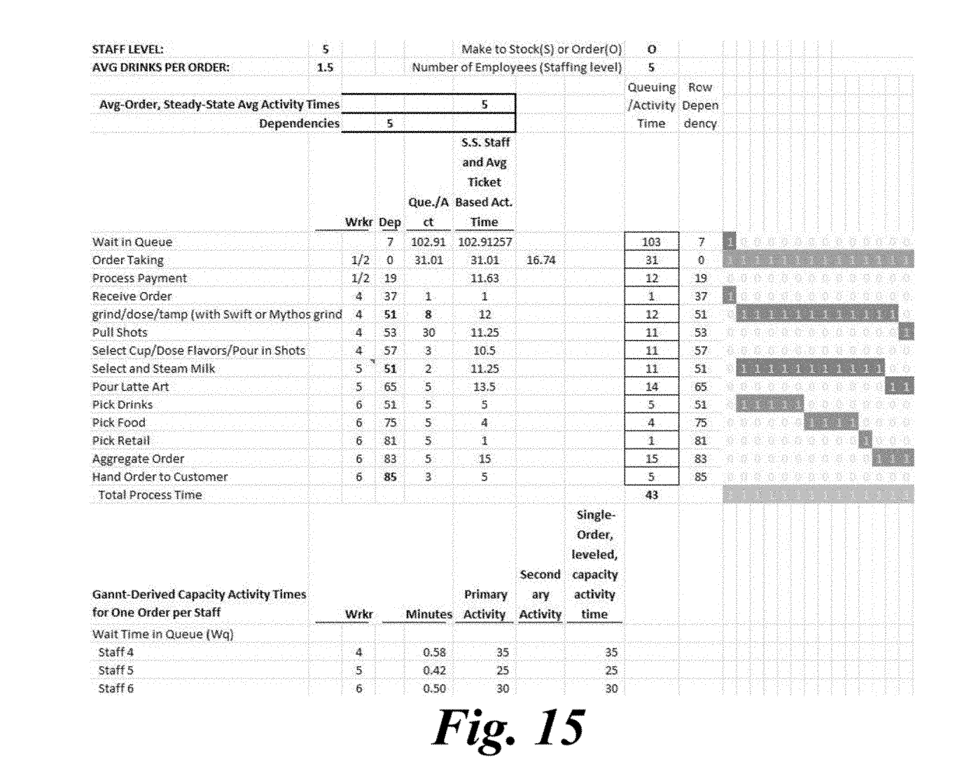

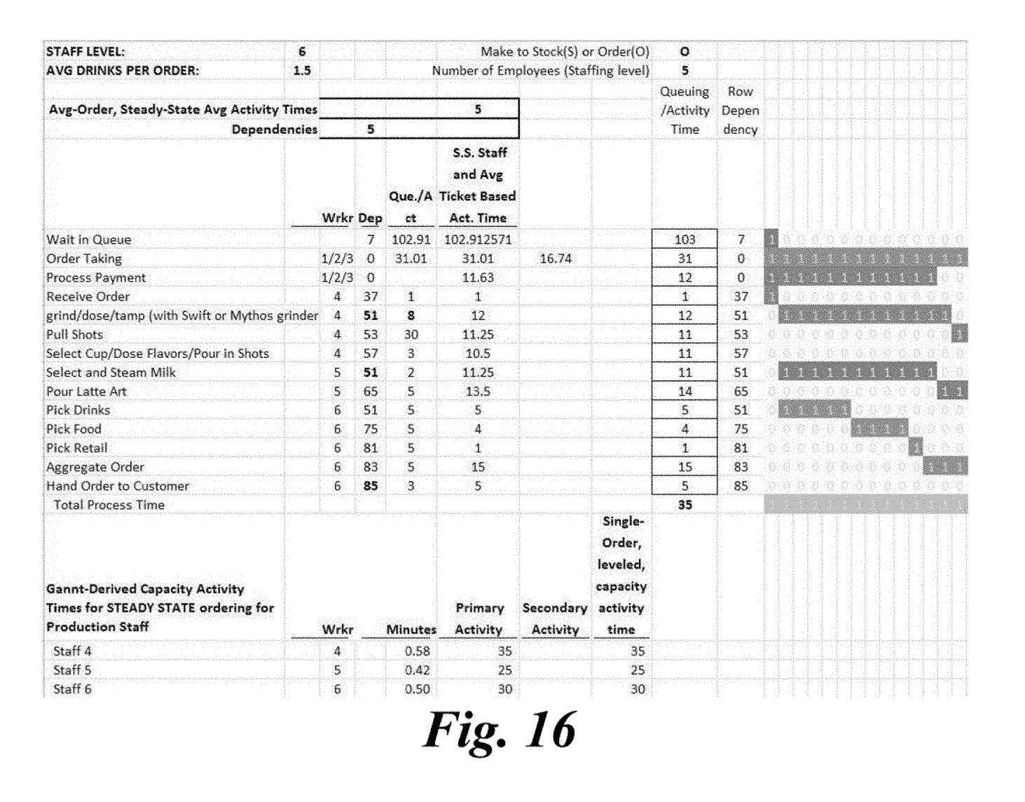

FIG. 11 illustrates Gantt order flow given one employee on staff; FIG. 12 given two employees on staff; FIG. 13 given three employees on staff; FIG. 14 given four employees on staff; FIG. 15 given five employees on staff; and FIG. 16 given six employees on staff. The Gannt chart for staffing from one to six employees modeled in FIGS. 11-16 demonstrate with detail how the production of items and item components can be done increasingly in parallel when staffing is increased and increasingly in series when staffing is decreased. These adjustments are one of many ways to improve the accuracy of order flow time estimates.

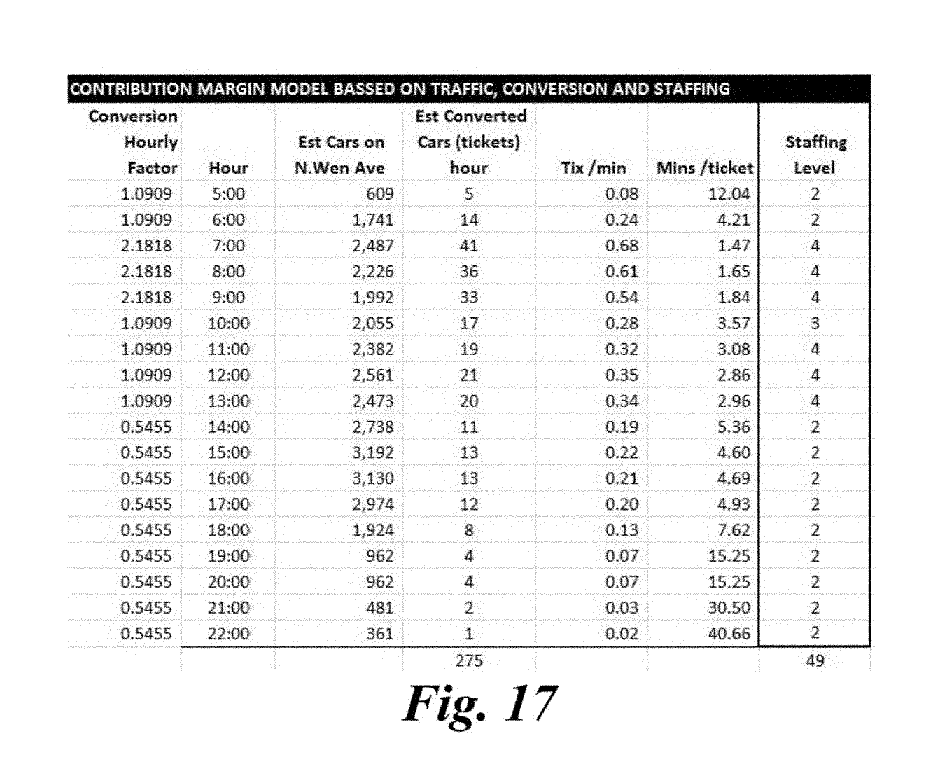

In yet another aspect and/or embodiment of the present invention, FIG. 17 illustrates an example of a dynamic staffing model dependent on a stipulated minimum service speed (a way to efficiently allocate labor resources dependent upon meeting service level goals) and an expected customer demand of orders which varies per hour.

FIGS. 18A and 18B illustrate one embodiment of the present invention and depict estimated order completion by regression. FIG. 18B illustrates one example of an Excel regression analysis output. Under “Regression Statistics,” the measures explain how well the calculated linear regression equation fits with the data. “Multiple R” is the correlation coefficient and indicates how strong the linear relationship is. For example, a value of 1 means a perfect positive relationship and a value of zero means no relationship at all. This variable is the square root of “R Squared.” “R Squared” is the coefficient of determination, which indicates how many points fall on the regression line. For example, 80% means that 80% of the variation of y-values around the mean are explained by the x-values. In other words, 80% of the values fit the model. “Adjusted R Square” adjusts for the number of terms in a model, which can be used if there is more than one x variable. “Standard Error” of the regression is an estimate of the standard deviation of the error μ. This is different from the standard error in descriptive statistics; rather, the standard error of the regression is the precision that the regression coefficient is measured. If the coefficient is large compared to the standard error, then the coefficient is probably different from 0. “Observations” is the number of observations in the sample.

Next, FIG. 18B illustrates the ANOVA (the analysis of variance). The variables include SS (Sum of Squares), Regression MS (Regression SS/Regression degrees of freedom), Residual MS (mean squared error (Residual SS/Residual degrees of freedom)), F (Overall F test for the null hypothesis) and Significance F (the significance associated P-Value). The ANOVA can be used to ascertain whether the regression analysis employed discovered any variance detrimental to operational efficiency per the flow charts illustrated in FIGS. 1-4.

FIG. 18B also illustrates specific information about the components a user chooses to include in the data analysis. The first column, therefore, indicates the various items (item1, item2, item3, etc.). The remaining columns indicate Coefficient (the least squares estimate), Standard Error (the least squares estimate of the standard error), T Statistic (the T Statistic for the null hypothesis vs. the alternate hypothesis), P Value (the p-value for the hypothesis test), Lower 95% (the lower boundary for the confidence interval), and Upper 95% (the upper boundary for the confidence interval). This part of FIG. 18B provides the user with the linear regression equation: y=mx+b; and y=slope*x+intercept.

While a preferred embodiment of the invention has been illustrated and described, as noted above, many changes can be made without departing from the spirit and scope of the invention. For example, the invention is not limited solely to food and beverages, but embodiments of the invention may be used with any perishable good, or even more generally, any good whose value or quality diminishes or vanishes over time. For example, in life sciences research, often tissue or cell samples may need to be obtain through various processes, and their research value is only during a short window, and embodiments of the present invention can improve the optimal timing of acquisition and delivery for experimental purposes. Similarly, organ transplants have delicately timed procedures on both the donor and done ends of the spectrum and embodiments of the present invention can be used to optimize the timing for maximum success of the procedure and patient survival. In both such applications, expected transport time may need to be dynamically adjusted, and embodiments of the Trigger invention can help improve the overall process.

The following table depicts a demonstrative use case example, which is not meant to be exhaustive, and instead, presents example embodiments of the present invention to achieve maximized quality/value of perishable/prepared goods for customers by timing the entry of remotely placed orders into a local production queue such that the completion of each order is optimally timed with the arrival of the customer at the designated pickup site. The following table is meant to serve as an example and is not the only use for and/or experience with this invention.

The consumer experience narrative (on the left side) and explanation of the background technology (on the right) serve to present one possible customer experience utilizing an embodiment of the present invention for one customer's morning coffee routine. The narrative on the left presents a more living, dynamic presentation of the dramatic benefits enabled one embodiment of the present invention. The right side column presents the aspects of the technology at work in the embodiment at each point in the consumer experience and the incremental value gained by the coffee vendor in comparison to the way coffee vendors handle the taking and production of remote orders at present.

| Consumer Experience Narrative | Description of Operative Technology |
|---|---|
| An average morning for John Smith: | Abbreviations Key: |
| I'm a customer of a high-end espresso | Proximity Queuing Trigger (PQT) |
| business that utilizes the proximity queuing | Estimated Production Time Database (PTD) |
| trigger for their order taking and production | Estimated Production Time (EPT) |
| scheduling system. | Estimated Arrival Times (EATs) |
| I have the “NewCoffeeCo” (NCC) app on my | As previously discussed, the system for taking |
| mobile phone. NCC is a high-end espresso | orders is comprised of, at least: |
| company that runs high-end coffee drive-thru | 1. a remote order taking system (i.e. a |
| and walk-up sites throughout my area. They | mobile phone/tablet app, a website, |
| have become known for top quality coffee | etc.) |
| that is extremely convenient. My wife and I | 2. a source of proximity data (i.e. the |
| have our own accounts. My office assistant | GPS, wifi, et al. location data from a |
| also has his own personal account. | mobile phone) and database for |
| I am a project manager at an IT company. I | customer proximity data |
| live in the suburbs 30 miles from my | 3. an On-Deck order database that collects |
| downtown office. I love high-end coffee but I | orders as they are placed |
| don't have much time to waste waiting for it. | 4. a database that estimates the production |
| I wake up at 7:00 am, jump in the shower, get | times for each item and order, and |
| dressed, grab my laptop, kiss Tiffany, my | 5. the Trigger software and database that |
| wife, and run out the door to make it 30 miles | sets the parameter for when an order is |
| to the office for my 8:00 am meeting with my | moved from the On-Deck database to a |
| project team. As I get in my car Tiffany tells | specific pickup location's production |
| me to order two 12 oz vanilla bean lattes for | queue |
| her. She likes to treat her publisher to a nice | |
| coffee during their meetings. | |
| I pull out of the driveway and as I head down | The NCC coffee app can either be installed |
| our street I dictate: | directly into the car's operating system and |
| | integrated into the car's mobile phone or the |
| | car's system is connected (e.g. through |
| | Bluetooth) to John's mobile phone app, which |
| | he calls through dictation in his car (similar to |
| | initiating dictation by saying “hey Siri” in |
| | Apple products or “Alexa” to Amazon's Echo |
| | product). |
| “NewCoffeeCo App: confirm my regular | The app recognizes the tag “NewCoffeeCo |
| order. | App” and registers his request to confirm his |
| | regular order. John has an account with NCC |
| | that stores his favorite drinks and usual |
| | locations. John has set an order and location as |
| | his “regular order.” |
| | When the NCC system receives the |
| | confirmation of his regular order, it puts his |
| | “regular order,” which stipulates all the items |
| | on the order, his ID, his payment information, |
| | and the assigned location, into the On-Deck |
| | database. The order waits On-Deck for the |
| | Trigger's signal to kick the order into the |
| | production queue at the designated pickup site. |
| “Also a new order of two vanilla bean lattes | The system recognizes “new order”, two |
| and two hazelnut macaroons for Tiffany.” | vanilla bean lattes and two hazelnut |
| (She loves those little cookie things . . . ) | macaroons. It then recognizes Tiffany and |
| | searches for accounts related to John's account |
| | by that name. It finds an account for Tiffany |
| | Smith, who is listed as John's wife on his |
| | account. It sees that John has permission to |
| | place orders for her and puts the order on her |
| | account. |
| The app responds through my car's speakers: | The system repeats the order back to John so |
| “Thank you for your order, Mr. Smith. Your | he can confirm its accuracy. It repeats his |
| Macchiato with Ethiopian Sidamo espresso | whole regular order by item and the regular |
| and spinach, gouda and scrambled egg | pickup location. |
| breakfast sandwich will be ready for you at | The system picks up his GPS coordinates and |
| our location at the intersection of 5^{th} Ave and | relates to John the traffic-adjusted arrival |
| Washington St. We expect you will be here in | estimate. |
| 4.75 minutes. | (This estimate did not recognize the traffic |
| | revision that he encounters. A mapping |
| | software like WAZE or Google Maps can |
| | recognize the traffic revision ahead of John's |
| | knowledge of it and proactively alert him |
| | and/or suggest an alternative pick up and take |
| | him down that decision tree with attending |
| | estimated arrival times, while also considering |
| | that the destination associated with John's |
| | regular order is his downtown office. |
| | Therefore, route and pickup location |
| | suggestions would be optimized for total speed |
| | to his ultimate, expected destination.) |
| “Tiffany's order of two vanilla bean lattes and | In the confirmation of Tiffany's order the |
| two hazelnut macaroons is confirmed. Where | system knows that it needs a pickup location to |
| would she like to pick those up?” | complete the order, so it asks John for it. |
| “I don't know,” I say. | John doesn't know and says so. |
| Tiffany's NCC app on her phone and tablets | The system needs to confirm with Tiffany the |
| alerts her and asks her to confirm the order | order items and fill in the unknown pickup |
| placed for her by John and to choose the | location before it can put the order into the On- |
| pickup location, either from a list of suggested | Deck database. So it sends Tiffany a |
| pickup locations or one that she stipulates. | confirmation request to the app on her phone. |
| (She didn't tell me where she was going . . . ) | The system knows which pickup locations are |
| She taps to confirm the second location, | her most frequently used so it suggests those |
| which is en route or on the way to her | based on her current location. |
| publisher's office, notices the macaroons, | Once she has confirmed the order and the |
| smiles, opens the app and cancels them off the | pickup location the system places the order in |
| order. | the On-Deck database to wait for the Trigger's |
| | signal to enter the order into the production |
| | queue at the pickup site. |
| I forgot the traffic revision! It takes me out of | The GPS data from John's mobile phone app |
| the way for my normal NCC pickup site. As I | goes out of the range of the expected route that |
| follow the detour I deviate from my normal | he would take to pick up his order. His order is |
| route and the NCC voice comes through my | still in the On-Deck database waiting for the |
| speakers, “Mr. Smith, we noticed that you | Trigger, because he is not close enough to the |
| have taken a different route. Would you like | pickup site yet. Since this embodiment of this |
| to change your pickup location to our 10^{th} and | kind of system uses GPS data, the system can |
| Madison location? This now seems to be most | adapt dynamically to his location. When his |
| convenient en route to your office. Or would | location goes off the expected route a rule is |
| you like to set a new destination address?” | triggered in the system for him to be sent an |
| | alert and for the system to recalculate his |
| | optimized route and pickup site for the order. |
| | There is another pickup site nearby that is |
| | calculated to be a more efficient option than |
| | his regular site due to the traffic revision. |
| | Therefore, the system recommends that his |
| | order be shifted to that pickup site. |
| “Confirm new location,” I say. | The system enables John to confirm the new |
| | location, and the system then logs the new |
| | pickup location. |
| “Thank you, Mr. Smith. We expect you to | The system changes the pickup location |
| arrive in 3.5 minutes.” | parameter on his On-Deck order to the new |
| | location, and updates the estimated travel time. |
| | The Trigger's operation is invisible to John . . . |
| | except in its good results. |
| | Because of the specific order items composing |
| | John's regular order & the staffing levels etc., |
| | the Trigger in this embodiment or example is |
| | set to aim for John's order to be finished 15 |
| | seconds before he arrives at the pickup site. |
| | When the estimated total flow time for John's |
| | order (through the production queue and |
| | production) is 2:15 and his expected arrival |
| | time is 2:30, the Trigger signals the On-Deck |
| | database and his order is placed in the pickup |
| | location production queue. |
| | The expected production time for his actual |
| | order of a macchiato and a pre-made sandwich |
| | might be something like 30 seconds and there |
| | might be a few orders already in the queue and |
| | production. So the estimated flow time for his |
| | order may come out to 2:15. |
| | Thus his order begins its flow through |
| | production in expectation of being ready 15 |
| | seconds before he arrives. |
| 4.5 minutes later I pull into the Express | While John's order was in the production |
| Window at NCC's 10^{th} and Madison location, | queue, the GPS part of the system sensed that |
| I'm 30 seconds late because I got stuck behind | he was moving slower than expected and told |
| a school bus with its stop sign out and lights | the production queue to bump his order one |
| flashing. The thing is, they are just finishing | slot back in the queue. Therefore, when he |
| my Sidamo Macchiato as I pull up to the | arrives they were just finishing his order, not |
| window. How do they always do that? | 15 seconds early like intended, but also not |
| | 1.25 mins early, like it would have been had |
| | the GPS system not intervened through the |
| | Trigger logic. |
| With a “Good morning, Mr. Smith” the | The huge benefit of timing this order correctly |
| barista passes my drink and sandwich through | is that the small, expensive coffee drink is |
| the window. It only took about 20 seconds for | perfectly fresh and hot. The intricate latte art, |
| me to pull up, get my stuff and drive off. As I | the skillful combination of the steamed milk |
| drive off I look through the clear plastic lid on | and espresso shots, is still beautiful, which |
| my small cup at the intricate latte art the | lasts for less than a minute. The result is that a |
| barista poured for me. The Ethiopian coffee's | customer paying a high price for top quality |
| exotic aroma, with hints of blueberry and | coffee experiences the full value of the product |
| cocoa, fills my car. | he demands and goes away happy. This |
| | increases their customer lifetime value |
| | tremendously and also their likelihood to |
| | recommend the business to friends. |
| | The barista has very little insight into the |
| | significant and complicated effort the system |
| | has gone through to deliver a perfectly-timed, |
| | high-end espresso drink to John. The order |
| | taking and payment taking process was all |
| | done through the NCC app and underlying |
| | system. The baristas staffing the pickup site |
| | simply employ their high-end coffee |
| | preparation skills on the latest order in the |
| | production queue and greet the customer by |
| | name (which shows up on their terminals for |
| | each order in process). |
| | The physical queue of cars at the pickup site |
| | can be very short or non-existent due to either |
| | the accurate timing of customer orders and |
| | lack of bottleneck at order/payment taking, or |
| | an alternate scheme of queuing cars for pickup |
| | can be employed, such as a parallel queue (like |
| | a Sonic Drive-Up or old fashioned drive-up |
| | burger place with roller skating waitresses). |
| As I take my first sip I realize that I forgot to | |
| place the coffee order for our meeting at | |
| 8:00am! | |
| I dictate: “NewCoffeeCo App: Drip coffee for | NCC's system receives a new order under |
| a 10 person meeting to be picked up by Tim | John's account for one of their 10-person |
| Jones close to my office.” | coffee service items. |
| | The system looks for a Tim Jones associated to |
| | John's account and finds him as an alternate |
| | person to pick up orders. |
| | The system also knows the address that John |
| | has associated with his office and selects his |
| | usual pickup site close to the office. |
| “Thanks for your order for a 10 Person Drip | The system confirms his order and sees that |
| Coffee Service, Mr. Smith. The pickup | there is a special coffee offer at that location |
| location by your office at Granite St and | for Costa Rican single origin and asks him to |
| South Columbia St is featuring a Costa Rican | confirm whether John would like the special or |
| single origin drip coffee. Does that coffee | the regular coffee. |
| selection work for you? Or would you prefer | |
| the NCC house blend?” | |
| At the same time, Tim's phone lights up with | Because John assigned the pickup to Tim the |
| a request from his NCC app asking him to | system sends a pickup invitation to Tim from |
| confirm an invite from me to pick up the | John asking him whether he will accept the |
| coffee order. He immediately clicks to | invitation. |
| confirm the pickup. He's prompt like that. | |
| “The Costa Rican,” I say. | |
| “Perfect. We will have Costa Rican Single | The system repeats the confirmed order to |
| Origin drip coffee for 10 people ready for | John, and because Tim has already confirmed |
| pickup when Tim Jones arrives. Tim has | the pickup, it relates that important fact to |
| confirmed the pickup location.” | John. |
| | The system places the order in the On-Deck |
| | orders database and begins to receive GPS data |
| | from Tim's phone. The Trigger will now |
| | balance the production queue against Tim's |
| | GPS location. The Trigger for a 10-person |
| | coffee service may have a different sensitivity |
| | than for John's macchiato. The sensitivity can |
| | be set based upon the vendor's understanding |
| | of their product and their value proposition to |
| | their customer. For example, a macchiato is |
| | extremely perishable so the Trigger has to be |
| | set very close (15 seconds in our example |
| | above) to the estimated arrival time, but an |
| | insulated container of drip coffee can maintain |
| | high quality for perhaps 45 minutes. Therefore |
| | the Trigger can be set such that the order is |
| | more certain to be ready immediately upon |
| | pickup, which may allow the production |
| | resources to be more efficiently utilized. (The |
| | tighter the Trigger tries to time expected order |
| | completion with expected customer arrival the |
| | higher the probability, due to production |
| | variability, that the order will not be finished |
| | when the customer arrives.) |
| That was the last thing I needed to do for the | The order simply waits in the On-Deck |
| meeting, so now I just get to sit back, turn on | database until the Trigger places it into the |
| my Moby Dick book on tape (my wife says | production queue at the pickup site based on |
| I'm not well read . . . ) and relax for the | Tim's proximity. |
| remaining 23 minutes of my commute. | There can also be an option to enter the order |
| | immediately into the production queue, which |
| | would be important if the customer were in the |
| | immediate vicinity of the pickup site when the |
| | order is placed. + invention would know that |
| | and know who to “activate”/juggle |
| | There can also be an option to Trigger an order |
| | into the production queue based on an |
| | estimated order completion time instead of |
| | proximity. This may be appropriate when a |
| | customer is too close to the pickup site for the |
| | Trigger to queue accurately due to the fact that |
| | the customer's expected travel time is always |
| | shorter than estimated production queue times. |
| Despite the unexpected detour and slight | |
| delay of the school bus, NCC had my | |
| expensive coffee ready in perfect time, and I | |
| only spent maybe 20 to 30 seconds extra to | |
| get my coffee. Getting just what I want . . . that | |
| fast . . . I love it! | |

While the preferred embodiment of the invention has been illustrated and described, as noted above, many changes can be made without departing from the spirit and scope of the invention. The various embodiments described above can be combined to provide further embodiments. Aspects can be modified, if necessary, to employ devices, features, methods and concepts of the various patents, applications and publications to provide yet further embodiments. Accordingly, the scope of the invention is not limited by the disclosure of the preferred embodiment. Instead, the invention should be determined entirely by reference to the claims that follow.

What is claimed is:

1. A method to optimize timing of production of a consumable with its procurement at a production site by a consumer the method comprising:
qualifying laborer competence to prepare the consumable based on consumable complexity;
remotely receiving an order at the production site for the consumable from the consumer;
calculating an estimated arrival time of the consumer at the production site to procure the consumable based on the proximity data conveyed from the consumer to the production site; and
assigning at least one qualified laborer to prepare the consumable based on the consumable complexity within a defined range about the expiration of the estimated arrival time to the production site.

2. The method of claim 1, wherein qualifying laborer competence to prepare the consumable based on consumable complexity includes qualifying the degree of production difficulty of the consumable relative to a plurality consumables available for the consumer to order.

3. The method of claim 1, wherein remotely receiving the order at the production site for the consumable from the consumer includes wired and wireless communication.

4. The method of claim 1, wherein calculating the arrival time includes proximity data derivable from at least one of GPS data, RFID, and Bluetooth transmissions obtainable from wireless communication from the consumer.

5. The method of claim 1, wherein assigning at least one laborer to prepare the consumable based on the consumable complexity within the arrival time at the production site includes laborers having been qualified to produce the consumable at a designated degree of difficulty matching the consumable ordered by the consumer among the plurality of consumables available to the consumer.

6. The method of claim 5, wherein the laborers having acquired mastery of producing at the designated degree of difficulty matching the consumable ordered by the consumer may be assigned in serial and parallel production cycles of other consumables among the plurality of consumables ordered by the consumer or other consumers.

7. The method of claim 1, wherein consumable complexity includes consumable perishability.

8. A method to optimize timing of production of a consumable with its procurement at a production site by a remotely located consumer the method comprising:
qualifying laborer competence by consumable complexity and storing with a production time database in communication with a local point of service system;
receiving an order for the consumable from the remotely located consumer;
calculating an initial estimated arrival time from proximity data conveyed from the remotely located consumer;
recalculating a revised estimated arrival time from changes in proximity data conveyed from the remotely located consumer;
performing regression analysis of at least one consumable complexity, menu items of consumables, laborer availability, and equipment availability to derive an estimated production time for the ordered consumable;
engaging a proximity queuing trigger based on the consumer's proximity to initiate the production of the ordered consumable; and
assigning at least one qualified laborer to produce the ordered consumable by its estimated production time within a defined range about the expiration of the consumer's revised estimated arrival time.

9. A method of claim 8 further comprising the step: using an analysis of variance to discover any variance(s) detrimental to operational efficiency.

10. A system to optimize timing of production of a consumable with its procurement at a production site by a remotely located consumer, the system comprising:
a global database having:
a production time database,
a first microprocessor-executable program having instructions to acquire queuing intelligence, accounting data, inventory data related to the consumable, personnel competence data to produce the consumable, equipment to utilize to produce the consumable, the first microprocessor-executable program having access to data stored in the production time database, and
a second microprocessor executable program configured with instructions to detect consumer location relative to the production site, storage of consumer location data in the production time database, and to initiate placement of the consumable within a production queue to finish the manufacture of the consumable by assigning the necessary qualified personnel within a defined period to the customer's arrival at the production site.
